(19) United States
(12) Patent Application Publication
(10) Pub. No.: US 2026/0112323 A1
(43) Pub. Date: Apr. 23, 2026

(54) DISPLAY DEVICE AND ELECTRONIC DEVICE INCLUDING THE SAME

(71) Applicant: SAMSUNG DISPLAY CO., LTD., YONGIN-SI (KR)

(72) Inventors: HYO-SANG YANG, Yongin-si (KR); HYUNWOO JEONG, Yongin-si (KR)

(21) Appl. No.: 19/295,838

(22) Filed: Aug. 11, 2025

(30) Foreign Application Priority Data
Oct. 17, 2024 (KR) 10-2024-0141857

(51) Int. Cl. G09G 3/3291; G09G 3/32

(52) U.S. Cl. CPC G09G 3/3291; G09G 3/32; G09G 2300/0819; G09G 2310/0275; G09G 2310/08; G09G 2320/0257; G09G 2330/021

(57) ABSTRACT

A display device includes a display panel including a plurality of pixels. A data driver supplies data voltages to the plurality of pixel. A driving driver supplies write scan signals and compensation scan signals to the plurality of pixels. The write scan signals may be respectively applied to a plurality of pixel rows. Each of the compensation scan signals may be applied to two pixel rows adjacent to each other in a first direction among the plurality of pixel rows. Among the compensation scan signals, a first activation period of a first compensation scan signal applied to a first pixel and a second activation period of a second compensation scan signal applied to a second pixel may have different durations from each other.

### CROSS-REFERENCE TO RELATED APPLICATIONS

This application claims priority under 35 U.S.C. § 119 to Korean Patent Application No. 10-2024-0141857, filed on Oct. 17, 2024 in the Korean Intellectual Property Office, the disclosure of which is hereby incorporated by reference in its entirety herein.

### 1. Technical Field

The present disclosure herein relates to a display device and an electronic device including the same, and more particularly, to a display device capable of reducing power consumption and increasing display quality and an electronic device including the same.

### 2. Discussion of Related Art

Among display devices, a light-emitting display device displays an image using a light-emitting diode that generates light through the recombination of electrons and holes. The light-emitting display device is self emissive and does not need a backlight. The light-emitting display device has the advantage of not only having a fast response speed, but also being driven by low power consumption.

The display device includes a display panel that displays an image, a gate driver sequentially supplying scan signals to scan lines provided in the display panel, and a data driver supplying data signals to data lines provided in the display panel.

### SUMMARY

The present disclosure provides a display device capable of reducing power consumption and increasing display quality and an electronic device including the same.

According to an embodiment of the present inventive concept, a display panel comprising a plurality of pixels. A data driver supplies data voltages to the plurality of pixels. A driving driver supplies write scan signals and compensation scan signals to the plurality of pixels. The write scan signals are respectively applied to a plurality of pixel rows. Each of the compensation scan signals is applied to two pixel rows adjacent to each other in a first direction among the plurality of pixel rows. The plurality of pixels comprise a first pixel and a second pixel spaced apart from the first pixel in the first direction. Each of the compensation scan signals comprises an activation period having an activation level. A first compensation scan signal among the compensation scan signals is applied to the first pixel and a second compensation scan signal among the compensation scan signals is applied to the second pixel. A duration of a first activation period of the first compensation scan signal is different from a duration of a second activation period of the second compensation scan signal.

In an embodiment, the driving driver includes a compensation driver receiving a first clock signal and a second clock signal and generating the compensation scan signals using the first clock signal and the second clock signal.

In an embodiment, the activation period of the compensation scan signals starts in response to a start point of a second enable period of the second clock signal, and the activation period of the compensation scan signals ends in response to an end point of a first enable period of the first clock signal.

In an embodiment, the second clock signal includes a (2-1)-th enable period overlapping the first activation period of the first compensation scan signal and a (2-2)-th enable period overlapping the second activation period of the second compensation scan signal. A duration of the (2-1)-th enable period is different from a duration of the (2-2)-th enable period.

In an embodiment, each of the compensation scan signals further includes a deactivation period having a deactivation level lower than the activation level and a front period having a first intermediate level between the activation level and the deactivation level, the front period preceding the start point of the second enable period.

In an embodiment, a duration of a first front period of the first compensation scan signal is different from a duration of a second front period of the second compensation scan signal.

In an embodiment, a sum of the duration of the first front period and the duration of the first activation period is equal to a sum of the duration of the second front period and the duration of the second activation period.

In an embodiment, the plurality of pixels further include a third pixel spaced apart from the second pixel in the first direction, and the second pixel is arranged between the first pixel and the third pixel.

In an embodiment, a third compensation scan signal among the compensation scan signals is applied to the third pixel, and a duration of a third front period of the third compensation scan signal is different from the duration of the first front period and the duration of the second front period.

In an embodiment, the duration of the second front period is longer than the duration of the first front period, and the duration of the third front period is longer than the duration of the second front period.

In an embodiment, the duration of the second front period is set to a value calculated using the duration of the first front period and the duration of the third front period.

In an embodiment, the duration of the first front period is obtained by correcting the duration of the second front period using a first compensation value, and the duration of the third front period is obtained by correcting the duration of the second front period using a second compensation value.

In an embodiment, each of the compensation scan signals further includes a back period following the end point of the first enable period, and each of the compensation scan signals has a second intermediate level between the activation level and the deactivation level in the back period.

In an embodiment, a duration of a first back period of the first compensation scan signal is equal to a duration of a second back period of the second compensation scan signal.

In an embodiment, each of the plurality of pixels includes a light-emitting element, a first transistor connected between the light-emitting element and a first power line, a second transistor connected to the first transistor and receiving the data voltage and the write scan signal, a third transistor connected to a control electrode of the first transistor and receiving the compensation scan signal, and a fourth transistor connected to the control electrode of the first transistor and receiving an initialization scan signal and an initialization voltage.

In an embodiment, the first transistor and the second transistor are PMOS transistors, and the third transistor and the fourth transistor are NMOS transistors.

In an embodiment of the present inventive concept, a display device may include a display panel including a first display region and a second display region adjacent to the first display region in a first direction, a data driver supplying data voltages to a plurality of pixels, and a driving driver supplying write scan signals and compensation scan signals to the plurality of pixels. The pixel includes a light-emitting element, a first transistor connected between the light-emitting element and a first power line, a second transistor connected to a first electrode of the first transistor and receiving one of the write scan signals, and a third transistor connected to a second electrode and a control electrode of the first transistor and receiving one of the compensation scan signals. Each of the compensation scan signals includes an activation period having an activation level, a deactivation period having a deactivation level lower than the activation level, and a front period having a first intermediate level between the activation level and the deactivation level, and a duration of a first front period of a first compensation scan signal provided to the first display region is different form a duration of a second front period of a second compensation scan signal provided to the second display region.

In an embodiment, the driving driver includes a compensation driver receiving a first clock signal and a second clock signal generating the compensation scan signals using the first clock signal and the second clock signal.

In an embodiment, the activation period of the compensation scan signals starts in response to a start point of a second enable period of the second clock signal, and the activation period of the compensation scan signals ends in response to an end point of a first enable period of the first clock signal.

In an embodiment, the second clock signal includes a (2-1)-th enable period overlapping a first activation period of the first compensation scan signal and a (2-2)-th enable period overlapping a second activation period of the second compensation scan signal, wherein a duration of the (2-1)-th enable period is different from a duration of the (2-2)-th enable period.

According to an embodiment of the present inventive concept, an electronic device may include a display panel configured to include a plurality of pixels, a data driver supplying data voltages to the plurality of pixels, a driving driver supplying write scan signals and compensation scan signals to the plurality of pixels, a driving controller receiving an image signal and a control signal and control an operation of the data driver and the driving driver, and a main processor providing the image signal and the control signal to the driving controller. The write scan signals are respectively applied to a plurality of pixel rows, each of the compensation scan signals is applied to two pixel rows adjacent to each other in a first direction among the plurality of pixel rows, the plurality of pixels include a first pixel and a second pixel spaced apart from the first pixel in the first direction, each of the compensation scan signals includes an activation period having an activation level, a first compensation scan signal among the compensation scan signals is applied to the first pixel and a second compensation scan signal among the compensation scan signals is applied to the second pixel a duration of a first activation period of the first compensation scan signal is different from a duration of a second activation period of the second compensation scan signal.

### BRIEF DESCRIPTION OF THE DRAWINGS

The accompanying drawings are included to provide a further understanding of the present inventive concept, and are incorporated in and constitute a part of this specification. The drawings illustrate non-limiting embodiments of the present inventive concept and, together with the description, serve to explain principles of the present inventive concept. In the drawings:

FIG. 1 is a perspective view of a display device according to an embodiment of the present inventive concept;

FIG. 2A is an exploded perspective view of the display device according to an embodiment of the present inventive concept;

FIG. 2B is a cross-sectional view of the display device according to an embodiment of the present inventive concept;

FIG. 3 is a block diagram of the display device according to an embodiment of the present inventive concept;

FIG. 4A is a circuit diagram of a pixel according to an embodiment of the present inventive concept;

FIG. 4B is a timing diagram for explaining the operation of the pixel according to an embodiment of the present inventive concept;

FIG. 5 is a block diagram of a display panel according to an embodiment of the present inventive concept;

FIG. 6A is a block diagram of a first driving driver according to an embodiment of the present inventive concept;

FIG. 6B is a block diagram of a second driving driver according to an embodiment of the present inventive concept;

FIG. 7 is a block diagram of a compensation driver according to an embodiment of the present inventive concept;

FIG. 8 is a circuit diagram of a compensation stage according to an embodiment of the present inventive concept;

FIG. 9A is a timing diagram of a compensation scan signal according to an embodiment of the present inventive concept;

FIG. 9B is a timing diagram of a compensation scan signal according to an embodiment of the present inventive concept;

FIG. 10A is a flowchart for setting the duration of a front period according to an embodiment of the present inventive concept;

FIG. 10B is a block diagram of a driving controller according to an embodiment of the present inventive concept;

FIG. 10C is a block diagram of a driving controller according to an embodiment of the present inventive concept;

FIG. 10D is a block diagram of a driving controller according to an embodiment of the present inventive concept; and

FIG. 11 is a block diagram of an electronic device according to an embodiment of the present inventive concept.

### DETAILED DESCRIPTION OF EMBODIMENTS

In this specification, it will be understood that when an element (or region, layer, portion, etc.) is referred to as being “on”, “connected to” or “coupled to” another element, it can be directly on, connected or coupled to the other element, or intervening elements may be present. When an element is referred to as being “directly on”, “directly connected to” or “directly coupled to” another element, no intervening elements may be present.

Like reference numerals refer to like elements throughout. In addition, in the drawings, the thicknesses, ratios, and dimensions of elements may be exaggerated for effective description of the technical contents. The term “and/or” includes any and all combinations that the associated configurations can define.

It will be understood that, although the terms first, second, etc. may be used herein to describe various elements, these elements should not be limited by these terms. These terms are only used to distinguish one element from another element. For example, a first element could be termed a second element without departing from the scope of the present invention. Similarly, the second element may also be referred to as the first element. Singular expressions include plural expressions unless the context clearly indicates otherwise.

In addition, terms, such as “below”, “lower”, “above”, “upper” and the like, are used herein for ease of description to describe one element's relation to another element(s) as illustrated in the figures. The above terms are relative concepts and are described based on the directions indicated in the drawings.

It will be understood that the terms “include” and/or “have”, when used in this specification, specify the presence of stated features, integers, steps, operations, elements, components and/or groups thereof, but do not preclude the presence or addition of one or more other features, integers, steps, operations, elements, components, and/or groups thereof.

The terms “part” and “unit” mean software components or hardware components that perform specific functions. A hardware component may include, for example, a field-programmable gate array (FPGA) or an application-specific integrated circuit (ASIC). A software component may refer to an executable code and/or a datum used by an executable code in an addressable storage medium. Therefore, software components may be, for example, object-oriented software components, class components, and working components, and include processes, functions, properties, procedures, subroutines, program code segments, drivers, firmware, microcodes, circuits, data, databases, data structures, tables, arrays or variables.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present inventive concept will be described with reference to the accompanying drawings.

The present disclosure concerns a display device having a driving driver that outputs scan signals which include a deactivation period having a deactivation level that is a low voltage level, an activation period having an activation level that is a high voltage level, and a front period having a first intermediate level that is a voltage level between the voltage level of the activation period and the voltage level of the deactivation period. The scan signals may change from the deactivation level to the activation level through the first intermediate level. Accordingly, a voltage level may be prevented from changing rapidly which reduces the power consumption of the display device.

The duration of the activation period may increase and a duration of the front period may decrease as the duration of a second enable signal increases. The duration of the activation period may decrease and a duration of the front period may increase as the duration of the second enable signal decreases. By controlling the durations of the front period and the activation period of the scan signals, the luminance of the plurality of pixels may be controlled. By setting the durations of the front period and the activation period of the scan signals so that the difference in luminance between two adjacent pixels among the plurality of pixels is minimized, it is possible to provide a display device with increased display quality.

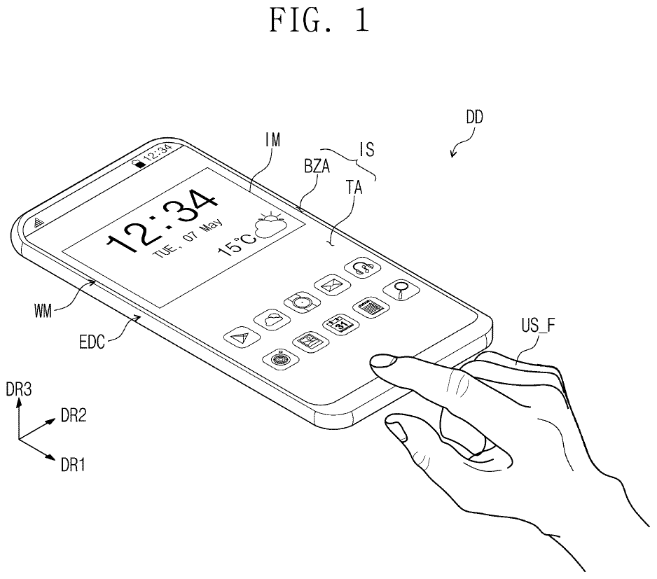

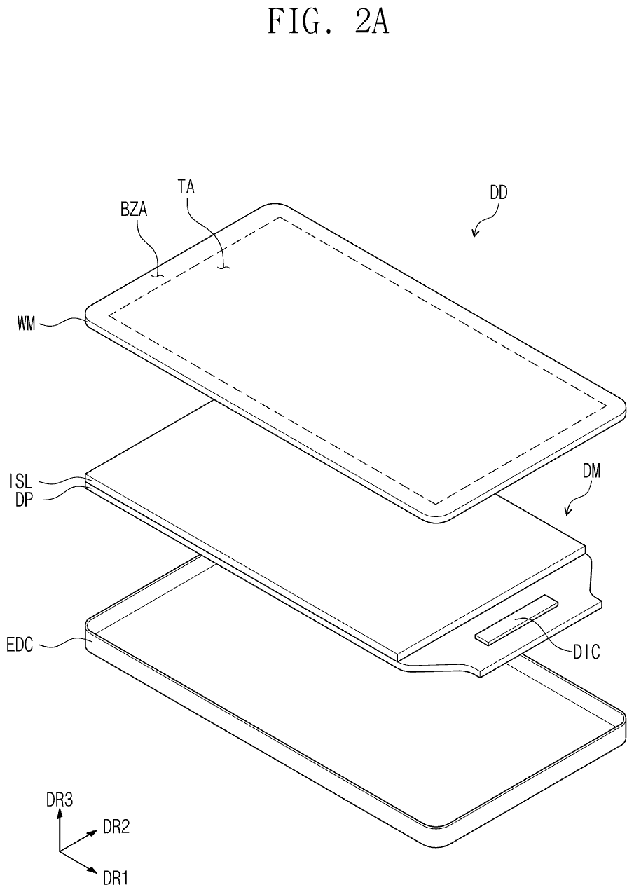

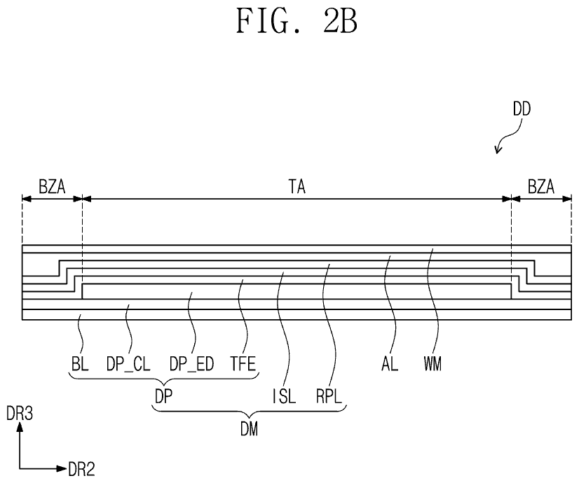

FIG. 1 is a perspective view of a display device according to an embodiment of the present inventive concept. FIG. 2A is an exploded perspective view of the display device according to an embodiment of the present inventive concept. FIG. 2B is a cross-sectional view of the display device according to an embodiment of the present inventive concept.

Referring to FIG. 1 and FIG. 2A, the display device DD according to an embodiment of the present inventive concept may have a rectangular shape (e.g., in a plan view) having long sides parallel to a first direction DR1 and short sides parallel to a second direction DR2 crossing the first direction DR1. Without being necessarily limited thereto, however, the display device DD may have various shapes (e.g., in a plan view) such as a circle, a polygon, etc.

The display device DD may be activated according to an electrical signal. The display device DD may include various embodiments. For example, in some embodiments the display device DD may be applied to electronic devices such as a smart watch, a tablet, a laptop, a computer, and a smart television.

Hereinafter, a normal direction substantially perpendicular to a plane defined by the first direction DR1 and the second direction DR2 is defined as a third direction DR3. In this specification, the expression “when viewed on a plane” may mean a state of being viewed from the third direction DR3.

The upper surface of the display device DD may be defined as a display surface IS and be parallel to a plane defined by the first direction DR1 and the second direction DR2. While the first and second directions DR1, D2 are shown as being perpendicular to each other, embodiments of the present inventive concept are not necessarily limited thereto and the first and second directions DR1, DR2 may cross each other at various different angles. Images IM generated in the display device DD may be provided to a user through the display surface IS.

The display surface IS may be divided into a transmission region TA and a bezel region BZA. The transmission region TA may be a region in which images IM are displayed. A user views the images IM through the transmission region TA. In this embodiment, the transmission region TA is illustrated as a square shape with rounded corners (e.g., in a plan view). However, this is illustrated as an example, and the transmission region TA may have various shapes and is not necessarily limited to any one embodiment.

The bezel region BZA is adjacent to the transmission region TA. In an embodiment, the bezel region BZA may have a predetermined color. The bezel region BZA may surround the transmission region TA (e.g., in a plan view). Accordingly, the shape of the transmission region TA may be substantially defined by the bezel region BZA. However, this is illustrated as an example, and the bezel region BZA may be disposed adjacent to only one side of the transmission region TA or may be omitted.

The display device DD may sense an external input applied from the outside (e.g., the external environment). The external input may include various types of inputs provided from the outside of the display device DD. For example, the external input may include not only a direct contact by a part of a body such as a user's hand US_F or a direct contact by a separate device (e.g., an active pen or digitizer, etc.), but also an external input (for example, hovering) applied in proximity to the display device DD or adjacent to the display device DD at a predetermined distance. In addition, the external input may have various forms such as force, pressure, temperature, and light.

The display device DD may include a window WM, a display module DM, and a housing EDC. In this embodiment, the window WM and the housing EDC are coupled to each other to form the exterior of the display device DD.

The front surface of the window WM defines the display surface IS of the display device DD. The window WM may include an optically transparent insulating material. For example, in an embodiment the window WM may include glass or plastic. The window WM may have a multi-layer structure or a single-layer structure. For example, in an embodiment the window WM may include a plurality of plastic films bonded to each other with an adhesive or include a glass substrate and a plastic film bonded to each other with an adhesive.

In an embodiment, the display module DM may include a display panel DP and an input sensing layer ISL. The display panel DP may display an image according to an electrical signal, and the input sensing layer ISL may sense an external input applied from the outside (e.g., the external environment). The external input may be provided in various forms.

The display panel DP according to an embodiment of the present inventive concept may be a light-emitting display panel, and embodiments of the present inventive concept are not particularly limited thereto. For example, the display panel DP may be an organic light-emitting display panel, an inorganic light-emitting display panel, or a quantum dot light-emitting display panel. The light-emitting layer of the organic light-emitting display panel may include an organic light-emitting material, and the light-emitting layer of the inorganic light-emitting display panel may include an inorganic light-emitting material. The light-emitting layer of the quantum dot light-emitting display panel may include quantum dots, quantum rods, etc. Hereinafter, the display panel DP is described as an organic light-emitting display panel for economy of explanation.

Referring to FIG. 2B, the display panel DP includes a base layer BL, a circuit layer DP_CL, an element layer DP_ED, and an encapsulation layer TFE. The display panel DP according to an embodiment may be a flexible display panel. However, embodiments of the present inventive concept are not necessarily limited thereto. For example, the display panel DP may be a rigid display panel or a foldable display panel that is folded based on a folding axis.

The base layer BL may include a synthetic resin layer. In an embodiment, the synthetic resin layer may be a polyimide-based resin layer, and its material is not particularly limited. In addition, the base layer BL may include a glass substrate, a metal substrate, or an organic/inorganic composite material substrate.

The circuit layer DP_CL is disposed on the base layer BL (e.g., disposed directly thereon in the third direction DR3). The circuit layer DP_CL is disposed between the base layer BL and the element layer DP_ED (e.g., in the third direction DR3). The circuit layer DP_CL includes at least one insulating layer and a circuit element. Hereinafter, the insulating layer included in the circuit layer DP_CL is referred to as an intermediate insulating layer. The intermediate insulating layer includes at least one intermediate inorganic film and at least one intermediate organic film. In an embodiment, the circuit element may include a pixel driving circuit included in each of a plurality of pixels for displaying an image, a sensor driving circuit included in each of a plurality of sensors for recognizing external information, and the like. The external information may be biometric information. In an embodiment, the sensor may be a fingerprint recognition sensor, a proximity sensor, an iris recognition sensor, a blood pressure measurement sensor, an illuminance sensor, or the like. In addition, the sensor may be an optical sensor that recognizes biometric information in an optical method. The circuit layer DP_CL may further include signal lines connected to the pixel driving circuit and/or the sensor driving circuit.

The element layer DP_ED may include a light-emitting element included in each of the pixels and a light-receiving element included in each of the sensors. In an embodiment, the light-receiving element may be a photodiode. The light-receiving element may be a sensor that senses light reflected by a user's fingerprint or reacts to light.

The encapsulation layer TFE seals the element layer DP_ED. The encapsulation layer TFE may include at least one organic film and at least one inorganic film. The inorganic film may include an inorganic material and protect the element layer DP_ED from moisture/oxygen. In an embodiment, the inorganic film may include, but is not necessarily limited to, a silicon nitride layer, a silicon oxy-nitride layer, a silicon oxide layer, a titanium oxide layer, an aluminum oxide layer, or the like. The organic layer may include an organic material and protect the element layer DP_ED from foreign substances such as dust particles.

The input sensing layer ISL may be formed on the display panel DP. In an embodiment, the input sensing layer ISL may be disposed directly on the encapsulation layer TFE (e.g., in the third direction DR3). According to an embodiment of the present inventive concept, the input sensing layer ISL may be formed on the display panel DP by a continuous process. For example, when the input sensing layer ISL is disposed directly on the display panel DP, an adhesive film is not disposed between the input sensing layer ISL and the encapsulation layer TFE. Alternatively, an adhesive film may be disposed between the input sensing layer ISL and the display panel DP (e.g., in the third direction DR3). In this embodiment, the input sensing layer ISL is not manufactured through a continuous process with the display panel DP, but may be manufactured through a process separate from that of the display panel DP and then bonded to the upper surface of the display panel DP with an adhesive film.

In an embodiment, the input sensing layer ISL may sense an external input (e.g., a user's touch), change it into a predetermined input signal, and provide the input signal to the display panel DP. The input sensing layer ISL may include a plurality of sensing electrodes for sensing an external input. The sensing electrodes may sense the external input in a capacitive manner. The display panel DP may receive the input signal from the input sensing layer ISL and generate an image corresponding to the input signal.

In an embodiment, the display module DM may further include a reflection prevention layer RPL. The reflection prevention layer RPL may reduce the reflectance of external light incident from above the display device DD towards the display panel DP. The external light may not be visible to a user due to the reflection prevention layer RPL. In an embodiment, the reflection prevention layer RPL may be disposed on (e.g., disposed directly thereon) the input sensing layer ISL. However, embodiments of the present inventive concept are not necessarily limited thereto. The reflection prevention layer RPL may be disposed between the display panel DP and the input sensing layer ISL. The reflection prevention layer RPL may include a plurality of color filters disposed to respectively correspond to the pixels. The color filters may filter external light into the same colors as the pixels. In this embodiment, the external light may not be visible to a user. However, embodiments of the present inventive concept are not necessarily limited thereto, and the reflection prevention layer RPL may include a retarder and/or a polarizer to reduce the reflectance of the external light.

The display device DD according to an embodiment of the present inventive concept may further include an adhesive layer AL. In an embodiment, the window WM may be attached to the reflection prevention layer RPL by the adhesive layer AL. In an embodiment, the adhesive layer AL may include an optically clear adhesive, an optically clear adhesive resin, or a pressure sensitive adhesive PSA.

Referring again to FIG. 2A, the display module DM may further include a driving chip DIC. In an embodiment, the driving chip DIC may be mounted on (e.g., directly thereon) the display panel DP to be adjacent to one end of the display panel DP, such as a lower end in the first direction DR1. Alternatively, however, the driving chip DIC may be mounted on a flexible circuit film coupled to one side of the display panel DP.

The housing EDC is coupled to the window WM. The housing EDC is coupled to the window WM to provide a predetermined internal space. The display module DM may be accommodated in the internal space. The housing EDC may include a material having relatively high rigidity. For example, in an embodiment the housing EDC may include a plurality of frames and/or plates made of glass, plastic, or metal, or a combination thereof. The housing EDC may stably protect the components of the display device DD accommodated in the internal space from an external impact. In an embodiment, a battery module or the like, which supplies power necessary for the overall operation of the display device DD, may be disposed between the display module DM and the housing EDC.

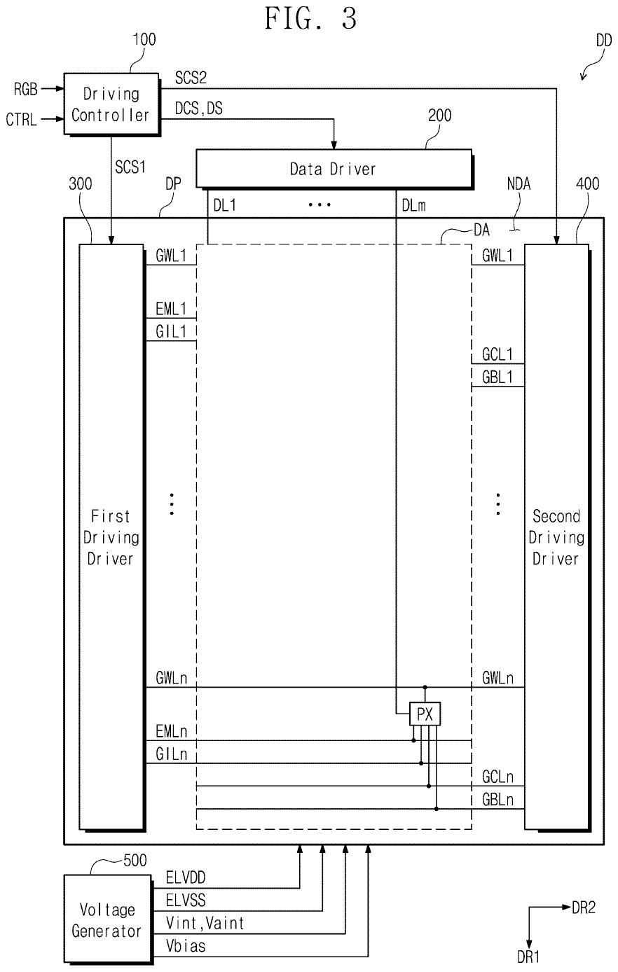

FIG. 3 is a block diagram of the display device according to an embodiment of the present inventive concept.

Referring to FIG. 3, the display device DD includes a display panel DP, a panel driver, and a driving controller 100. In an embodiment, the panel driver includes a data driver 200, a first driving driver 300, a second driving driver 400, and a voltage generator 500.

The driving controller 100 receives an image signal RGB and a control signal CTRL. In an embodiment, the driving controller 100 generates image data DS by converting the data format of the image signal RGB to match the interface specifications of the data driver 200. The driving controller 100 outputs a first control signal SCS1, a second control signal SCS2, and a third control signal DCS.

The data driver 200 receives the third control signal DCS and the image data DS from the driving controller 100. The data driver 200 converts the image data DS into data signals and outputs the data signals to a plurality of data lines DL1 to DLm described below. The data signals are analog voltages corresponding to the grayscale values of the image data DS. In an embodiment, the data driver 200 may be embedded in the driving chip DIC illustrated in FIG. 2A.

The first driving driver 300 receives the first control signal SCS1 from the driving controller 100, and the second driving driver 400 receives the second control signal SCS2 from the driving controller 100. The first driving driver 300 and the second driving driver 400 may output scan signals to the scan lines in response to the first control signal SCS1 and the second control signal SCS2, respectively.

The voltage generator 500 generates voltages necessary for the operation of the display panel DP. In an embodiment, the voltage generator 500 generates a first driving voltage ELVDD, a second driving voltage ELVSS, a first initialization voltage Vint, a second initialization voltage Vaint, a bias voltage Vbias, and a reset voltage Vrst.

The display panel DP may include a display region DA corresponding to the transmission region TA (as illustrated in FIG. 1) and a non-display region NDA corresponding to the bezel region BZA (as illustrated in FIG. 1).

The display panel DP may include a plurality of pixels PX disposed in the display region DA. In an embodiment, the display panel DP further includes initialization scan lines GIL1 to GILn, compensation scan lines GCL1 to GCLn, write scan lines GWL1 to GWLn, black scan lines GBL1 to GBLn, light-emitting control lines EML1 to EMLn, and data lines DL1 to DLm. The initialization scan lines GIL1 to GILn, the compensation scan lines GCL1 to GCLn, the write scan lines GWL1 to GWLn, the black scan lines GBL1 to GBLn, and the light-emitting control lines EML1 to EMLn extend in the second direction DR2. The initialization scan lines GIL1 to GILn, the compensation scan lines GCL1 to GCLn, the write scan lines GWL1 to GWLn, the black scan lines GBL1 to GBLn, and the light-emitting control lines EML1 to EMLn are spaced apart from each other in the first direction DR1. The data lines DL1 to DLm extend in the first direction DR1 and are spaced apart from each other in the second direction DR2. Here, n and m are natural numbers greater than or equal to 1.

The plurality of pixels PX are electrically connected to the initialization scan lines GIL1 to GILn, the compensation scan lines GCL1 to GCLn, the write scan lines GWL1 to GWLn, the black scan lines GBL1 to GBLn, the light-emitting control lines EML1 to EMLn, and the data lines DL1 to DLm, respectively. For example, each of the plurality of pixels PX may be electrically connected to four scan lines. However, the number of the scan lines connected to each pixel PX is not necessarily limited thereto and may be changed.

The first driving driver 300 and the second driving driver 400 may be disposed in the non-display region NDA of the display panel DP. The first driving driver 300 receives the first control signal SCS1 from the driving controller 100. In response to the first control signal SCS1, the first driving driver 300 may output write scan signals to the write scan lines GWL1 to GWLn, initialization scan signals to the initialization scan lines GIL1 to GILn, and light-emitting control signals to the light-emitting control lines EML1 to EMLn. In response to the second control signal SCS2, the second driving driver 400 may output write scan signals to the write scan lines GWL1 to GWLn, compensation scan signals to the compensation scan lines GCL1 to GCLn, and black scan signals to the black scan lines GBL1 to GBLn.

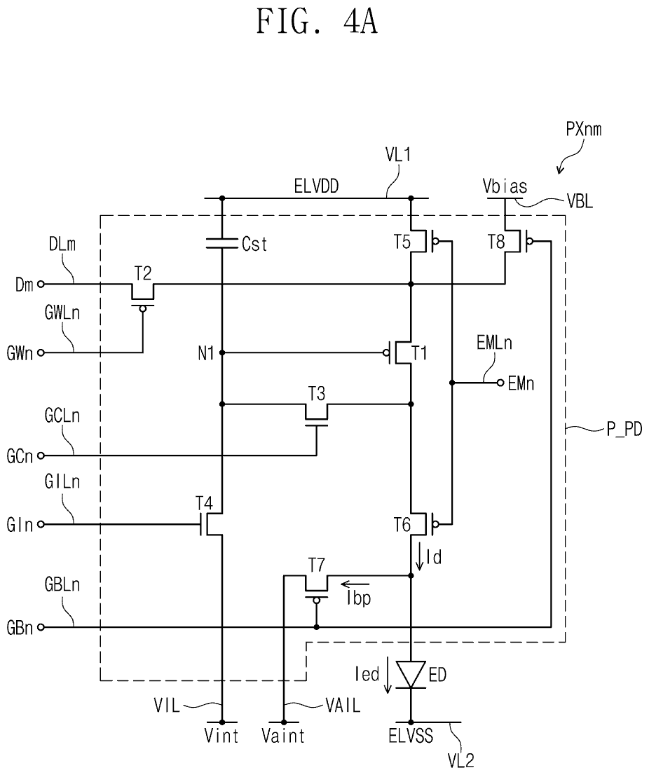

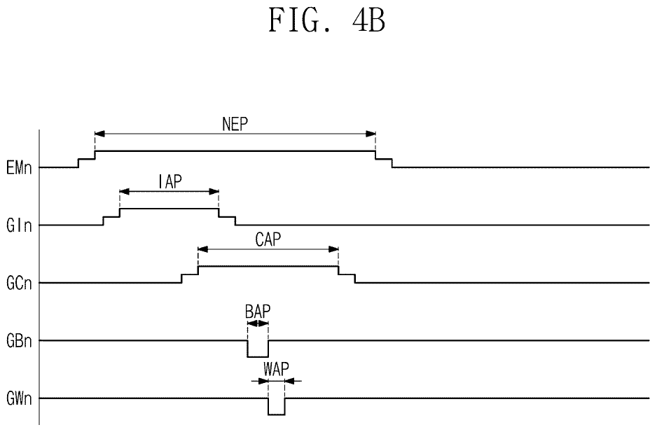

FIG. 4A is a circuit diagram of a pixel according to an embodiment of the present inventive concept. FIG. 4B is a timing diagram for explaining the operation of the pixel according to an embodiment of the present inventive concept.

FIG. 4A illustrates an equivalent circuit diagram of one pixel PXnm among the plurality of pixels PX illustrated in FIG. 3. Since each of the plurality of pixels PX has a same circuit structure, the description of the circuit structure of the pixel PXnm will be equally applied to those of the remaining pixels, and the descriptions of the circuit structures of the remaining pixels will be omitted.

Referring to FIG. 4A, the pixel PXnm is connected to an m-th data line DLm among the data lines DL1 to DLm, an n-th initialization scan line GILn among the initialization scan lines GIL1 to GILn, an n-th compensation scan line GCLn among the compensation scan lines GCL1 to GCLn, an n-th write scan line GWLn among the write scan lines GWL1 to GWLn, an n-th black scan line GBLn among the black scan lines GBL1 to GBLn, and an n-th light-emitting control line EMLn among the light-emitting control lines EML1 to EMLn.

The pixel PXnm includes a light-emitting element ED and a pixel driving circuit P_PD. The light-emitting element ED may be a light-emitting diode. In an embodiment, the light-emitting element ED may be an organic light-emitting diode including an organic light-emitting layer.

In an embodiment, the pixel driving circuit P_PD includes first to eighth transistors T1, T2, T3, T4, T5, T6, T7, and T8 and one capacitor Cst. At least one of the first to eighth transistors T1 to T8 may have a low-temperature polycrystalline silicon (LTPS) semiconductor layer. Some of the first to eighth transistors T1 to T8 may be P-type transistors (e.g., PMOS transistors), and the remainder may be N-type transistors (e.g., NMOS transistors). At least one of the first to eighth transistors T1 to T8 may have an oxide semiconductor layer. For example, the third and fourth transistors T3 and T4 may be oxide semiconductor transistors, and the first, second, fifth to eighth transistors T1, T2, and T5 to T8 may be LTPS transistors. The third and fourth transistors T3 and T4 may be NMOS transistors.

The configuration of the pixel driving circuit P_PD according to embodiments of the present disclosure are not necessarily limited to an embodiment illustrated in FIG. 4A. The pixel driving circuit P_PD illustrated in FIG. 4A is only an example, and the configuration of the pixel driving circuit P_PD may be modified and implemented. For example, all of the first to eighth transistors T1 to T8 may be P-type transistors or N-type transistors. In addition, one of the transistors in the pixel driving circuit P_PD may be omitted or additional transistors may be added in the pixel driving circuit P_PD.

The n-th initialization scan line GILn, the n-th compensation scan line GCLn, the n-th write scan line GWLn, the n-th black scan line GBLn, and the n-th light-emitting control line EMLn may transmit, to the pixel PXnm, an n-th initialization scan signal GIn, an n-th compensation scan signal GCn, an n-th write scan signal GWn, an n-th black scan signal GBn, and an n-th light-emitting control signal EMn, respectively. The m-th data line DLm transmits an m-th data signal Dm to the pixel PXnm. The m-th data signal Dm may have a voltage level corresponding to the image signal RGB (see FIG. 3) input to the display device DD (see FIG. 3).

In an embodiment, the pixel PXnm may be connected to first and second driving voltage lines VL1 and VL2, first and second initialization voltage lines VIL and VAIL, and a bias voltage line VBL. The first driving voltage line VL1 may transmit the first driving voltage ELVDD to the pixel PXnm, and the second driving voltage line VL2 may transmit the second driving voltage ELVSS to the pixel PXnm. In addition, the first initialization voltage line VIL may transmit the first initialization voltage Vint to the pixel PXnm, and the second initialization voltage line VAIL may transmit the second initialization voltage Vaint to the pixel PXnm. The bias voltage line VBL may transmit the bias voltage Vbias to the pixel PXnm.

The first transistor T1 is connected between the light-emitting element ED and the first driving voltage line VL1 configured to receive the first driving voltage ELVDD. The first transistor T1 includes a first electrode connected to the first driving voltage line VL1 via the fifth transistor T5, a second electrode connected to the anode electrode of the light-emitting element ED via the sixth transistor T6, and a third electrode (e.g., a gate electrode) connected to one end (e.g., a first node N1) of the capacitor Cst. The first transistor T1 may receive the m-th data signal Dm transmitted by the m-th data line DLm according to the switching operation of the second transistor T2 and supply a driving current Id to the light-emitting element ED.

The second transistor T2 is connected between the m-th data line DLm and the first electrode of the first transistor T1. The second transistor T2 includes a first electrode connected to the m-th data line DLm, a second electrode connected to the first electrode of the first transistor T1, and a third electrode (e.g., a gate electrode) connected to the n-th write scan line GWLn. In an embodiment, the second transistor T2 may be turned on according to the n-th write scan signal GWn received through the n-th write scan line GWLn, allowing the m-th data signal Dm received from the m-th data line DLm to be transmitted to the first electrode of the first transistor T1

The third transistor T3 is connected between the second electrode of the first transistor T1 and the first node N1. The third transistor T3 includes a first electrode connected to the third electrode of the first transistor T1, a second electrode connected to the second electrode of the first transistor T1, and a third electrode (e.g., a gate electrode) connected to the n-th compensation scan line GCLn. In an embodiment, the third transistor T3 may be turned on according to the n-th compensation scan signal GCn received through the n-th compensation scan line GCLn and connect the third electrode and the second electrode of the first transistor T1 to each other, thereby being able to diode-connect the first transistor T1.

The fourth transistor T4 is connected between the first node N1 and the first initialization voltage line VIL to which the first initialization voltage Vint is applied. The fourth transistor T4 includes a first electrode connected to the first initialization voltage line VIL to which the first initialization voltage Vint is transmitted, a second electrode connected to the first node N1, and a third electrode (e.g., a gate electrode) connected to the n-th initialization scan line GILn. In an embodiment, the fourth transistor T4 is turned on according to the n-th initialization scan signal GIn received through the n-th initialization scan line GILn. The turned-on fourth transistor T4 transmits the first initialization voltage Vint to the first node N1 to initialize the potential of the third electrode of the first transistor T1 (e.g., the potential of the first node N1).

The fifth transistor T5 includes a first electrode connected to the first driving voltage line VL1, a second electrode connected to the first electrode of the first transistor T1, and a third electrode (e.g., a gate electrode) connected to the n-th light-emitting control line EMLn.

The sixth transistor T6 includes a first electrode connected to the second electrode of the first transistor T1, a second electrode connected to the anode electrode of the light-emitting element ED, and a third electrode (e.g., a gate electrode) connected to the n-th light-emitting control line EMLn.

In an embodiment, the fifth and sixth transistors T5 and T6 are simultaneously turned on according to the n-th light-emitting control signal EMn received through the n-th light-emitting control line EMLn. The first driving voltage ELVDD applied through the turned-on fifth transistor T5 may be compensated through the diode-connected first transistor T1 and then transmitted to the light-emitting element ED.

The seventh transistor T7 includes a first electrode connected to the second initialization voltage line VAIL to which the second initialization voltage Vaint is transmitted, a second electrode connected to the second electrode of the sixth transistor T6, and a third electrode (e.g., a gate electrode) connected to the n-th black scan line GBLn. In an embodiment, the second initialization voltage Vaint may have a voltage level lower than or equal to that of the first initialization voltage Vint.

The eighth transistor T8 includes a first electrode connected to the bias voltage line VBL to which the bias voltage Vbias is transmitted, a second electrode connected to the first electrode of the first transistor T1, and a third electrode (e.g., a gate electrode) connected to the n-th black scan line GBLn.

In an embodiment, the seventh and eighth transistors T7 and T8 are simultaneously turned on according to the n-th black scan signal GBn transmitted through the n-th black scan line GBLn. The second initialization voltage Vaint applied through the turned-on seventh transistor T7 may be transmitted to the anode electrode of the light-emitting element ED. Therefore, the anode electrode of the light-emitting element ED may be initialized by the second initialization voltage Vaint. The bias voltage Vbias applied through the turned-on eighth transistor T8 may be transmitted to the first electrode of the first transistor T1. Accordingly, the bias voltage Vbias may be periodically applied to the first electrode of the first transistor T1, and as a result, it is possible to prevent issues such as deterioration of display quality caused by the potential difference between the first and second electrodes of the first transistor T1, which increases beyond a certain level due to a hysteresis phenomenon.

As described above, one end of the capacitor Cst is connected to the third electrode of the first transistor T1, and the other end thereof is connected to the first driving voltage line VL1. The cathode electrode of the light-emitting element ED may be connected to the second driving voltage line VL2 that transmits the second driving voltage ELVSS. The second driving voltage ELVSS may have a voltage level lower than that of the first driving voltage ELVDD. In an embodiment, the second driving voltage ELVSS may have a voltage level lower than those of the first and second initialization voltages Vint and Vaint.

Referring to FIGS. 4A and 4B, the n-th light-emitting control signal EMn has a high level during a non-light-emitting period NEP. Within the non-light-emitting period NEP, the n-th initialization scan signal GIn is activated. In an embodiment, during an initialization activation period IAP of the n-th initialization scan signal GIn, when the n-th initialization scan signal GIn of a high level is provided through the n-th initialization scan line GILn, the fourth transistor T4 is turned on in response to the high-level n-th initialization scan signal GIn. The first initialization voltage Vint is transmitted to the third electrode of the first transistor T1 through the turned-on fourth transistor T4, and the first node N1 is initialized by the first initialization voltage Vint. Therefore, the initialization activation period IAP may be defined as an initialization period of the pixel PXnm.

In an embodiment, when the n-th compensation scan signal GCn is then activated, and during a compensation activation period CAP of the n-th compensation scan signal GCn, when the n-th compensation scan signal GCn of a high level is provided through the n-th compensation scan line GCLn, the third transistor T3 is turned on. The first transistor T1 is diode-connected by the turned-on third transistor T3 and is forward-biased. In an embodiment shown in FIG. 4B, the initialization activation period IAP partially overlaps the compensation activation period CAP, but the initialization activation period IAP and the compensation activation period CAP may not overlap each other in some embodiments.

The n-th write scan signal GWn is activated within the compensation activation period CAP. The n-th write scan signal GWn has a low level during a write activation period WAP. In an embodiment, during the write activation period WAP, the second transistor T2 is turned on by the n-th write scan signal GWn of a low level. In an embodiment, a compensation voltage “Dm-Vth”, which is reduced by as much as a threshold voltage Vth of the first transistor T1 based on the m-th data signal Dm provided by the m-th data line DLm, is then applied to the third electrode of the first transistor T1. For example, the potential of the third electrode of the first transistor T1 may be the compensation voltage “Dm-Vth”. The write activation period WAP may overlap the compensation activation period CAP. The duration of the compensation activation period CAP may be longer than the duration of the write activation period WAP.

The first driving voltage ELVDD and the compensation voltage “Dm-Vth” may be applied to both ends of the capacitor Cst, and a charge corresponding to the voltage difference between the two ends may be stored in the capacitor Cst. Here, the high level period of the n-th compensation scan signal GCn may be referred to as the compensation period of the pixel PXnm.

In an embodiment, the n-th black scan signal GBn is activated within the compensation activation period CAP of the n-th compensation scan signal GCn. The n-th black scan signal GBn has a low level during a black activation period BAP. During the black activation period BAP, the seventh transistor T7 is turned on by receiving the n-th black scan signal GBn of a low level through the n-th black scan line GBLn. A portion of the driving current Id driven by the seventh transistor T7 may be discharged through the seventh transistor T7 as a bypass current Ibp. The black activation period BAP may overlap the compensation activation period CAP. The duration of the compensation activation period CAP may be longer than the duration of the black activation period BAP. The black activation period BAP may precede (e.g., immediately precede) the write activation period WAP and may not overlap the write activation period WAP.

In a case in which the light-emitting element ED emits light even when the minimum driving current of the first transistor T1 flows as the driving current Id while the pixel PXnm is displaying a black image, the pixel PXnm may not properly display the black image. Accordingly, the seventh transistor T7 in the pixel PXnm according to an embodiment of the present inventive concept may distribute a portion of the minimum driving current of the first transistor T1 as a bypass current Ibp to a current path other than the current path towards the light-emitting element ED. Here, the minimum driving current of the first transistor T1 means a current flowing to the first transistor T1 under the condition that the first transistor T1 is turned off as a gate-source voltage Vgs of the first transistor T1 is lower than the threshold voltage Vth. Under such a condition that the first transistor T1 is turned off, the minimum driving current (e.g., a current less than or equal to about 10 pA) flowing to the first transistor T1 is transmitted to the light-emitting element ED, and a black grayscale image is displayed. When the pixel PXnm displays a black image, the influence of the bypass current Ibp on the minimum driving current is relatively large, whereas when displaying an image such as a general image or a white image, it can be said that there is almost no influence of the bypass current Ibp on the driving current Id. Therefore, when displaying a black image, a current (e.g., a light-emitting current Ied) reduced by the amount of the bypass current Ibp that flows out from the driving current Id through the seventh transistor T7 is provided to the light-emitting element ED, so that the black image can be clearly expressed. Therefore, the pixel PXnm may implement an accurate black grayscale image by using the seventh transistor T7, and as a result, a contrast ratio may be increased.

In an embodiment, the n-th light-emitting control signal EMn provided from the n-th light-emitting control line EMLn is changed from a high level to a low level. The fifth and sixth transistors T5 and T6 are turned on by the light-emitting control signal EMn of a low level. In an embodiment, the driving current Id is then generated according to the voltage difference between the voltage of the third electrode of the first transistor T1 and the first driving voltage ELVDD, and the driving current Id is supplied to the light-emitting element ED through the sixth transistor T6, so that the current Ied flows through the light-emitting element ED.

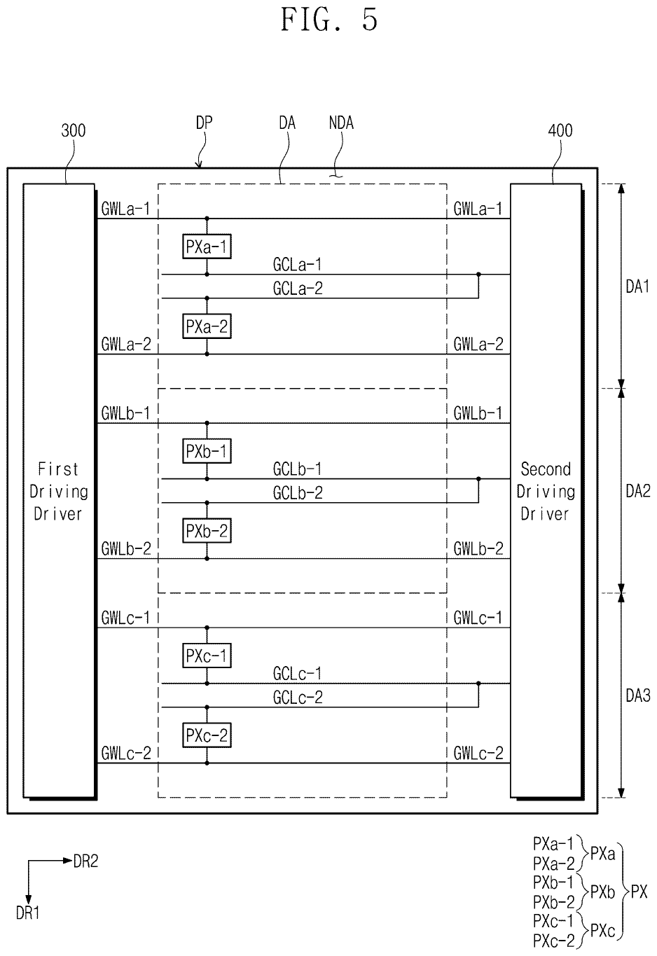

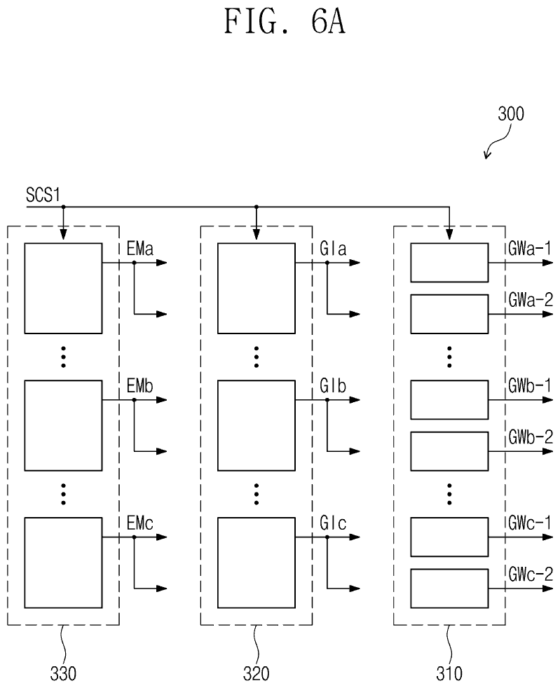

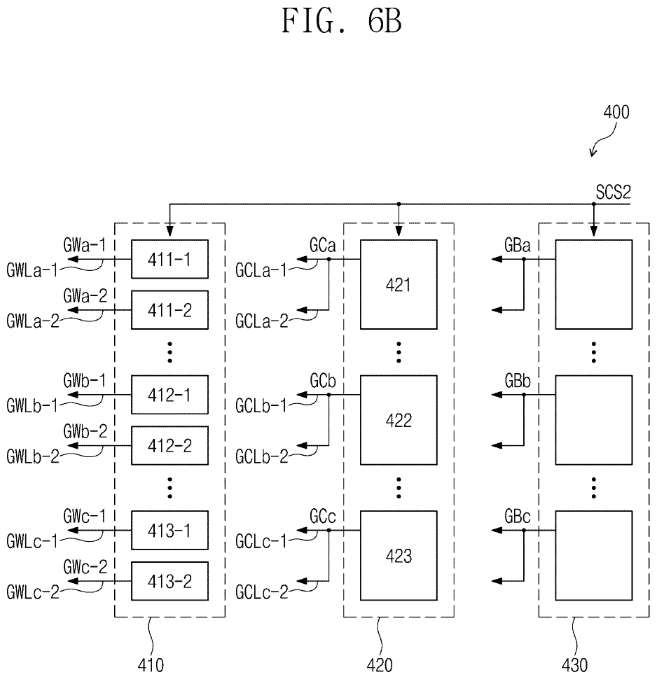

FIG. 5 is a block diagram of a display panel according to an embodiment of the present inventive concept. FIG. 6A is a block diagram of a first driving driver according to an embodiment of the present inventive concept. FIG. 6B is a block diagram of a second driving driver according to an embodiment of the present inventive concept.

Referring to FIG. 5, the display panel DP may include a display region DA and a non-display region NDA.

In an embodiment, the display region DA may be divided into a first display region DA1, a second display region DA2, and a third display region DA3 (e.g., arranged along the first direction DR1). The second display region DA2 may be adjacent to the first display region DA1 and the third display region DA3 in the first direction DR1, and the third display region DA3 may be adjacent to the second display region DA2 in the first direction DR1. The second display region DA2 may be located between the first display region DA1 and the third display region DA3 in the first direction DR1. In an embodiment, the first display region DA1 may correspond to the upper region of the display region DA, the second display region DA2 may correspond to the middle region thereof, and the third display region DA3 may correspond to the lower region thereof.

A plurality of pixels PX may be disposed in the display region DA. Among the plurality of pixels PX disposed in the display region DA, the pixels disposed in the first display region DA1 are referred to as first pixels PXa, the pixels disposed in the second display region DA2 are referred to as second pixels PXb, and the pixels disposed in the third display region DA3 are referred to as third pixels PXc. For example, the second pixels PXb may be spaced apart from the first pixels PXa and the third pixels PXc in the first direction DR1, and the third pixels PXc may be spaced apart from the second pixels PXb in the first direction DR1. The second pixels PXb may be arranged between the first pixels PXa and the third pixels PXc (e.g., in the first direction DR1).

Among the first pixels PXa disposed in the first display region DA1, a pixel disposed in an odd-numbered pixel row (or a first pixel row) is referred to as a (1-1)-th pixel PXa-1, and a pixel disposed in an even-numbered pixel row (or a second pixel row) is referred to as a (1-2)-th pixel PXa-2. The (1-1)-th pixels PXa-1 and the (1-2)-th pixels PXa-2 may be adjacent to each other in the first direction DR1. Among the second pixels PXb disposed in the second display region DA2, a pixel disposed in an odd-numbered pixel row is referred to as a (2-1)-th pixel PXb-1, and a pixel disposed in an even-numbered pixel row is referred to as a (2-2)-th pixel PXb-2. The (2-1)-th pixels PXb-1 and the (2-2)-th pixels PXb-2 may be adjacent to each other in the first direction DR1. Among the third pixels PXc disposed in the third display region DA3, a pixel disposed in an odd-numbered pixel row is referred to as a (3-1)-th pixel PXc-1, and a pixel disposed in an even-numbered pixel row is referred to as a (3-2)-th pixel PXc-2. The (3-1)-th pixels PXc-1 and the (3-2)-th pixels PXc-2 may be adjacent to each other in the first direction DR1.

The first driving driver 300 and the second driving driver 400 may be disposed in the non-display region NDA. Like the plurality of pixels PX illustrated in FIG. 3, the plurality of pixels PX of FIG. 5 may be connected to the first driving driver 300 through the write scan lines GWL1 to GWLn, the light-emitting control lines EML1 to EMLn, and the initialization scan lines GIL1 to GILn, and to the second driving driver 400 through the write scan lines GWL1 to GWLn, the compensation scan lines GCL1 to GCLn, and the black scan lines GBL1 to GBLn. For the convenience of explanation, however, FIG. 5 illustrates only a structure in which four scan lines (e.g., two write scan lines and two compensation scan lines) are disposed in each of the first to third display regions DA1 to DA3, and the illustration of the remaining scan lines is omitted for economy of explanation.

The (1-1)-th, (2-1)-th, and (3-1)-th pixels PXa-1, PXb-1, and PXc-1 may be referred to as odd-numbered row pixels, and the (1-2)-th, (2-2)-th, and (3-2)-th pixels PXa-2, PXb-2, and PXc-2 may be referred to as even-numbered row pixels. The odd-numbered row pixels and the even-numbered row pixels may be disposed adjacent to each other in the first direction DR1. The odd-numbered row pixels and the even-numbered row pixels disposed adjacent to each other are connected to different write scan lines and receive different write scan signals, respectively. In an embodiment, the odd-numbered row pixels and the even-numbered row pixels disposed adjacent to each other are connected to different compensation scan lines, but may receive a same compensation scan signal.

Referring to FIGS. 5, 6A, and 6B, in an embodiment the (1-1)-th pixel PXa-1 is connected to a (1-1)-th write scan line GWLa-1 to receive a (1-1)-th write scan signal GWa-1, and the (1-2)-th pixel PXa-2 is connected to a (1-2)-th write scan line GWLa-2 to receive a (1-2)-th write scan signal GWa-2. The (1-1)-th pixel PXa-1 is connected to a (1-1)-th compensation scan line GCLa-1, and the (1-2)-th pixel PXa-2 is connected to a (1-2)-th compensation scan line GCLa-2. In an embodiment, the (1-1)-th compensation scan line GCLa-1 is electrically connected to the (1-2)-th compensation scan line GCLa-2. Accordingly, the (1-1)-th compensation scan line GCLa-1 and the (1-2)-th compensation scan line GCLa-2 may receive a first compensation scan signal GCa from the second driving driver 400.

However, embodiments of the present inventive concept are not necessarily limited thereto, and the (1-1)-th pixel PXa-1 and the (1-2)-th pixel PXa-2 may be connected to one compensation scan line to receive the first compensation scan signal GCa. Referring to FIGS. 5, 6A, and 6B, in an embodiment the first driving driver 300 may include a write driver 310, an initialization driver 320, and a light-emitting driver 330, and the second driving driver 400 may include a write driver 410, a compensation driver 420, and a black driver 430. The write driver 310, the initialization driver 320, and the light-emitting driver 330 may respectively output a write scan signal, an initialization scan signal, and a light-emitting control signal in response to the first control signal SCS1. The write driver 410, the compensation driver 420, and the black driver 430 may respectively output a write scan signal, a compensation scan signal, and a black scan signal in response to the second control signal SCS2.

Aside from the difference that the write driver 310 of FIG. 6A is disposed at one end of the display panel DP and the write driver 410 of FIG. 6B is disposed at the other end of the display panel DP, both are similar in that they provide write scan signals GWa-1, GWa-2, GWb-1, GWb-2, GWc-1, and GWc-2 to a plurality of pixels PX and have similar configurations. Therefore, hereinafter, the description of the write driver 410 of FIG. 6B is used in place of the description for the write driver 310 of FIG. 6A for economy of explanation.

In an embodiment, the write driver 410 may include a plurality of write stages 411-1, 411-2, 412-1, 412-2, 413-1, and 413-2. Each of the plurality of write stages 411-1 to 413-2 may apply a corresponding write scan signal among the write scan signals GWa-1, GWa-2, GWb-1, GWb-2, GWc-1, and GWc-2 to one pixel row. For example, the (1-1)-th write stage 411-1 may output the (1-1)-th write scan signal GWa-1 to the (1-1)-th pixel PXa-1 through the (1-1)-th write scan line GWLa-1, and the (1-2)-th write stage 411-2 may output the (1-2)-th write scan signal GWa-2 to the (1-2)-th pixel PXa-2 through the (1-2)-th write scan line GWLa-2. Similarly, the (2-1)-th write stage 412-1 and the (2-2)-th write stage 412-2 may respectively output the (2-1)-th write scan signal GWb-1 and the (2-2)-th write scan signal GWb-2 to the (2-1)-th pixel PXb-1 and the (2-2)-th pixel PXb-2, and the (3-1)-th write stage 413-1 and the (3-2)-th write stage 413-2 may respectively output the (3-1)-th write scan signal GWc-1 and the (3-2)-th write scan signal GWc-2 to the (3-1)-th pixel PXc-1 and the (3-2)-th pixel PXc-2.

The compensation driver 420 may include a plurality of compensation stages 421, 422, and 423. Each of the plurality of compensation stages 421, 422, and 423 may apply a corresponding compensation scan signal among compensation scan signals GCa, GCb, and GCc to pixels disposed in two adjacent pixel rows. For example, in an embodiment a first compensation stage 421 may output the first compensation scan signal GCa to the (1-1)-th pixel PXa-1 and the (1-2)-th pixel PXa-2. Although FIG. 5 illustrates that the (1-1)-th pixel PXa-1 receives the first compensation scan signal GCa through the (1-1)-th compensation scan line GCLa-1 and the (1-2)-th pixel PXa-2 receives the first compensation scan signal GCa through the (1-2)-th compensation scan line GCLa-2, embodiment of the present inventive concept are not necessarily limited thereto, and the (1-1)-th pixel PXa-1 and the (1-2)-th pixel PXa-2 may receive the first compensation scan signal GCa through a same compensation scan line. Similarly, in an embodiment a second compensation stage 422 may output a second compensation scan signal GCb to the (2-1)-th pixel PXb-1 and the (2-2)-th pixel PXb-2 through a (2-1)-th compensation scan line GCLb-1 and a (2-2)-th compensation scan line GCLb-2, respectively, and a third compensation stage 423 may output a third compensation scan signal GCc to the (3-1)-th pixel PXc-1 and the (3-2)-th pixel PXc-2 through a (3-1)-th compensation scan line GCLc-1 and a (3-2)-th compensation scan line GCLc-2, respectively.

In an embodiment, the compensation driver 420 may apply a compensation scan signal, which is output from one compensation stage, to pixels disposed in two pixel rows. Accordingly, the number of compensation stages for driving pixels may be reduced, thus being able to reduce the width of the bezel region BZA (see FIG. 1).

In addition, in an embodiment the initialization driver 320 may apply each of initialization scan signals GIa, GIb, and GIc to pixels disposed in two pixel rows, the light-emitting driver 330 may apply each of light-emitting control signals EMa, EMb, and EMc to pixels disposed in two pixel rows, and the black driver 430 may apply each of black scan signals GBa, GBb, and GBc to pixels disposed in two pixel rows. The initialization driver 320, the light-emitting driver 330, and the black driver 430 are similar to each other in that they apply a same scan signal through the scan lines respectively corresponding to the pixels disposed in the two pixel rows, except that they output scan signals different from those of the compensation driver 420. Therefore, duplicate descriptions are omitted for economy of explanation.

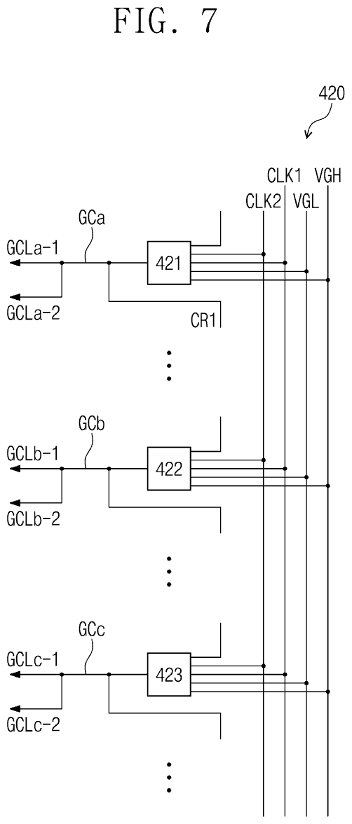

FIG. 7 is a block diagram of a compensation driver according to an embodiment of the present inventive concept. FIG. 8 is a circuit diagram of a compensation stage according to an embodiment of the present inventive concept. FIG. 8 representatively illustrates the internal circuit of the first compensation stage 421. Since the internal circuits of the remaining compensation stages 422 and 423 are similar to the internal circuit of the first compensation stage 421, the description of the first compensation stage 421 is used in place of the descriptions for the remaining compensation stages 422 and 423.

Referring to FIG. 7 and FIG. 8, the first compensation stage 421 is connected to first to third input terminals IN1, IN2, and IN3, first and second voltage terminals V1 and V2, and first and second output terminals OUT1 and OUT2. First and second clock signals CLK1 and CLK2 are respectively applied to the first and second input terminals IN1 and IN2. In an embodiment, the first and second clock signals CLK1 and CLK2 may have a predetermined phase difference from each other. In an embodiment, the clock signals input to the first and second input terminals IN1 and IN2 may be inverted on a per-compensation stage basis. For example, when the first and second clock signals CLK1 and CLK2 are input to the first and second input terminals IN1 and IN2 of the first compensation stage 421, the second and first clock signals CLK2 and CLK1 may be input to the first and second input terminals IN1 and IN2 of the second compensation stage 422.

In an embodiment, a start signal FLM may be input to the third input terminal IN3 of the first compensation stage 421. Instead of the start signal FLM, a carry signal output from a previous driving stage may be provided to the third input terminal IN3. For example, a first carry signal CR1 output from the first compensation stage 421 may be provided to the third input terminal IN3 of the second compensation stage 422.

A first voltage VGH is applied to the first voltage terminal V1, and a second voltage VGL is applied to the second voltage terminal V2. In an embodiment, the second voltage VGL may have a voltage level lower than that of the first voltage VGH. The first output terminal OUT1 may output the first compensation scan signal GCa, and the second output terminal OUT2 may output the first carry signal CR1. The first carry signal CR1 may be substantially the same as the first compensation scan signal GCa. In an embodiment, the first compensation scan signal GCa may have the same voltage level as that of the first voltage VGH during an activation period, and the same level as that of the second voltage VGL during a deactivation period.

The first compensation stage 421 includes a control circuit CC and an output circuit OC. In an embodiment, the control circuit CC may include first to sixth driving transistors DT1 to DT6 and first and second driving capacitors C1 and C2, and the output circuit OC may include first and second output transistors OT1 and OT2. In an embodiment, the control circuit CC may control the potentials of first and second nodes NQ and NQB in response to the first and second clock signals CLK1 and CLK2 and the start signal FLM. Here, the potential of the first node NQ may be referred to as a first control signal, and the potential of the second node NQB may be referred to as a second control signal. The first and second output transistors OT1 and OT2 may output the first compensation scan signal GCa in response to the first and second control signals, respectively.

The first driving transistor DT1 is connected between the third input terminal IN3 and the third node N3 and includes a gate electrode connected to the first input terminal IN1. The second and third driving transistors DT2 and DT3 are connected in series between the second voltage terminal V2 and the third node N3. In an embodiment, the gate electrode of the second driving transistor DT2 is connected to the second node NQB, and the gate electrode of the third driving transistor DT3 is connected to the second input terminal IN2.

The fourth driving transistor DT4 is connected between the second node NQB and the first input terminal IN1 and includes a gate electrode connected to the third input terminal IN3. The fifth driving transistor DT5 is connected between the second node NQB and the first voltage terminal V1 and includes a gate electrode connected to the first input terminal IN1. The sixth driving transistor DT6 is connected between the first node NQ and the third node N3 and includes a gate electrode connected to the first voltage terminal V1.

The first driving capacitor C1 is connected between the first node NQ and the first output terminal OUT1. The second driving capacitor C2 is connected between the second node NQB and the second voltage terminal V2.

In an embodiment, in response to the start signal FLM and the first and second clock signals CLK1 and CLK2, the control circuit CC outputs the first control signal for controlling the first output transistor OT1 through the first node NQ and outputs the second control signal for controlling the second output transistor OT2 through the second node NQB. FIG. 8 illustrates a structure in which the control circuit CC includes six driving transistors DT1 to DT6 and two driving capacitors C1 and C2, but the configuration of the control circuit CC is not necessarily limited thereto. For example, the number and connection relationship of the driving transistors and the driving capacitors included in the control circuit CC may be variously modified.

The output circuit OC includes first and second output transistors OT1 and OT2. The first output transistor OT1 is connected between the second input terminal IN2 and the first output terminal OUT1 and includes a gate electrode connected to the first node NQ. The second output transistor OT2 is connected between the second voltage terminal V2 and the first output terminal OUT1 and includes a gate electrode connected to the second node NQB.

In an embodiment, the first output transistor OT1 is turned on in response to the first control signal, and the second clock signal CLK2 is provided to the first output terminal OUT1 through the turned-on first output transistor OT1, thereby activating the first compensation scan signal GCa.

In an embodiment, the second output transistor OT2 is turned on in response to the second control signal, and the second voltage VGL is provided to the first output terminal OUT1 through the turned-on second output transistor OT2, thereby deactivating the first compensation scan signal GCa.

The first compensation scan signal GCa is activated and may be applied to the (1-1)-th pixel PXa-1 (see FIG. 5) through the (1-1)-th compensation scan line GCLa-1 and to the (1-2)-th pixel PXa-2 (see FIG. 5) through the (1-2)-th compensation scan line GCLa-2.

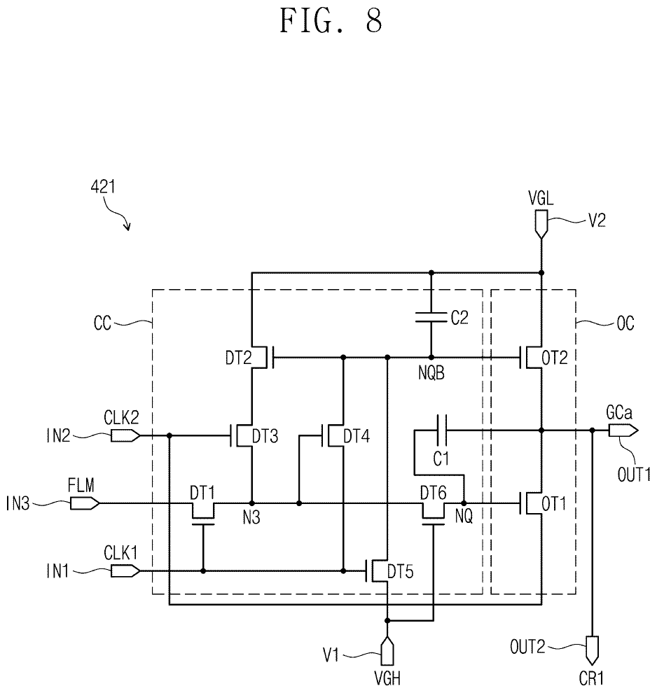

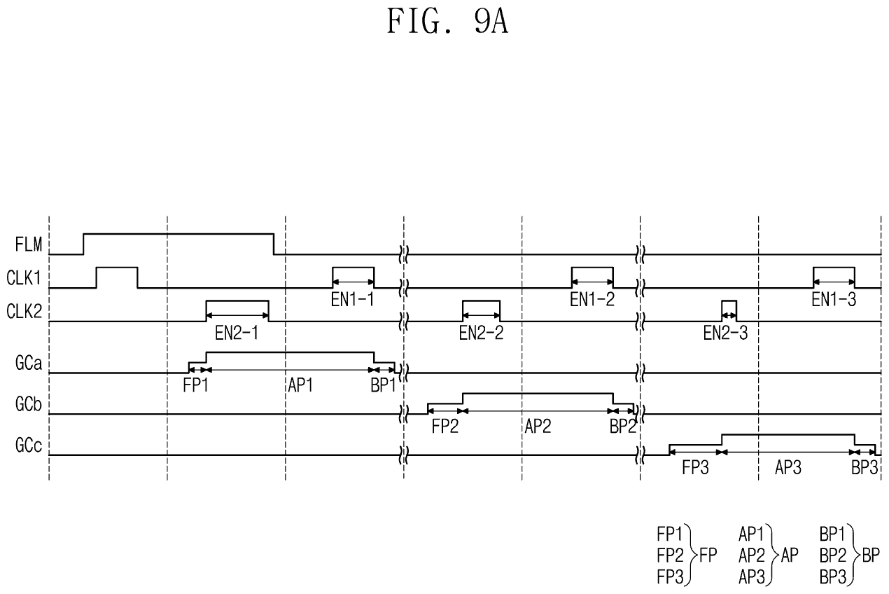

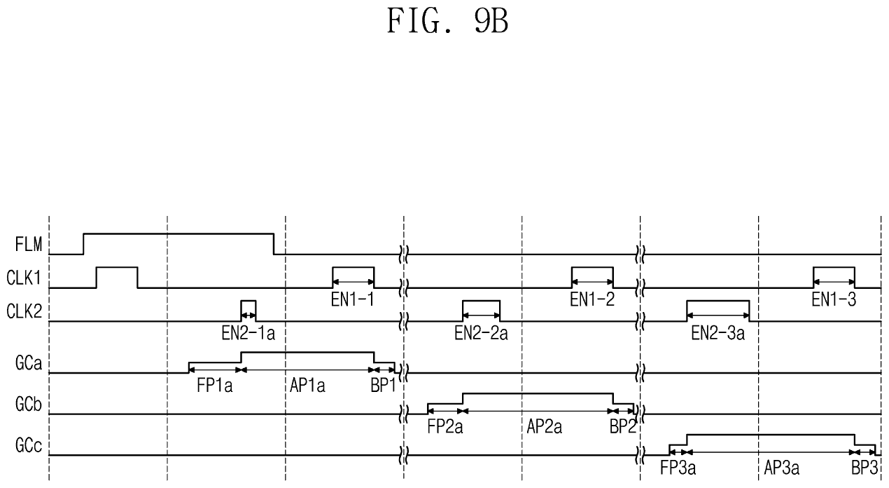

FIG. 9A is a timing diagram of a compensation scan signal according to an embodiment of the present inventive concept. FIG. 9B is a timing diagram of a compensation scan signal according to an embodiment of the present inventive concept. FIGS. 9A and 9B illustrate the timing diagrams of the first compensation scan signal GCa, the second compensation scan signal GCb, and the third compensation scan signal GCc respectively output to the first, second, and third pixels PXa, PXb, and PXc (see FIG. 5).

Referring to FIG. 9A, each of the compensation scan signals GCa, GCb, and GCc may include an activation period AP having an activation level (e.g., a high voltage level), a front period FP having a first intermediate level (e.g., a ground voltage), and a back period BP having a second intermediate level (e.g., a ground voltage). In an embodiment, the front period FP may precede (e.g., immediately precede) the activation period AP, and the back period BP may follow (e.g., immediately follow) the activation period AP. In an embodiment, the first intermediate level and the second intermediate level may be voltage levels between the activation level (e.g., a high voltage level) and the deactivation level (e.g., a low voltage level), and the first intermediate level and the second intermediate level may be the same as each other.

In an embodiment, each of the compensation scan signals GCa, GCb, and GCc may be activated in response to the first clock signal CLK1 and the second clock signal CLK2.

In an embodiment, the first clock signal CLK1 may include a first enable period EN1-1, EN1-2, and EN1-3 having an activation level (e.g., a high voltage level), and the second clock signal CLK2 may include a second enable period EN2-1, EN2-2, and EN2-3 having an activation level (e.g., a high voltage level). In an embodiment, the activation period AP of the compensation scan signal GCa, GCb, or GCc may start in response to the start point of the second enable period EN2-1, EN2-2, or EN2-3, and the activation period AP of the compensation scan signal GCa, GCb, or GCc may end in response to the end point of the first enable period EN1-1, EN1-2, or EN1-3. For example, the first activation period AP1 of the first compensation scan signal GCa may overlap the (1-1)-th enable period EN1-1 and the (2-1)-th enable period EN2-1, the second activation period AP2 of the second compensation scan signal GCb may overlap the (1-2)-th enable period EN1-2 and the (2-2)-th enable period EN2-2, and the third activation period AP3 of the third compensation scan signal GCc may overlap the (1-3)-th enable period EN1-3 and the (2-3)-th enable period EN2-3.

In an embodiment, the respective durations of the activation periods AP of the compensation scan signals GCa, GCb, and GCc may be different from each other. For example, in an embodiment, the duration of the first activation period AP1 may be longer than the duration of the second activation period AP2, and the duration of the second activation period AP2 may be longer than the duration of the third activation period AP3.

In an embodiment, the duration of the activation period AP may be set by the duration of the second enable period EN2-1, EN2-2, or EN2-3 of the second clock signal CLK2. Since the start point of the activation period AP may be determined by the second enable period EN2-1, EN2-2, or EN2-3, as the duration of the second enable period EN2-1, EN2-2, or EN2-3 increases, the duration of a corresponding activation period AP increases. In an embodiment, to set the duration of the first activation period AP1 to be longer than the duration of the second activation period AP2, the duration of the (2-1)-th enable period EN2-1 may be set to be longer than the duration of the (2-2)-th enable period EN2-2. Similarly, to set the duration of the second activation period AP2 to be longer than the duration of the third activation period AP3, the duration of the (2-2)-th enable period EN2-2 may be set to be longer than the duration of the (2-3)-th enable period EN2-3.

The respective durations of the front periods FP of the compensation scan signals GCa, GCb, and GCc may be different from each other. In an embodiment, the duration of a first front period FP1 may be shorter than the duration of a second front period FP2, and the duration of the second front period FP2 may be shorter than the duration of a third front period FP3.

In an embodiment, as the duration of the activation period AP is set by the duration of the second enable period EN2-1, EN2-2, or EN2-3 of the second clock signal CLK2, the duration of the front period FP may be set by the duration of the second enable period EN2-1, EN2-2, or EN2-3 of the second clock signal CLK2. For example, as the duration of the second enable period EN2-1, EN2-2, or EN2-3 increases, the duration of a corresponding front period FP may decrease. Accordingly, for each compensation scan signal GCa, GCb, or GCc, the sum of the duration of the front period FP and the duration of the activation period AP may be equal to each other.

In an embodiment, the respective durations of the back periods BP of the compensation scan signals GCa, GCb, and GCc may be equal to each other. For example, as illustrated in FIG. 9A, a first back period BP1, a second back period BP2, and a third back period BP3 may have the same duration as each other. However, embodiments of the present inventive concept are not necessarily limited thereto, and the durations of the first back period BP1, the second back period BP2, and the third back period BP3 may be different from each other in some embodiments.

Referring to FIG. 9B, in an embodiment, the duration of a first activation period AP1a may be shorter than the duration of a second activation period AP2a, and the duration of the second activation period AP2a may be shorter than the duration of a third activation period AP3a.

In an embodiment, to set the duration of the first activation period AP1a to be shorter than the duration of the second activation period AP2a, the duration of a (2-1)-th enable period EN2-1a may be set to be shorter than the duration of a (2-2)-th enable period EN2-2a. Likewise, to set the duration of the second enable period AP2a to be shorter than the duration of the third enable period AP3a, the duration of the (2-2)-th enable period EN2-2a may be set to be shorter than the duration of the (2-3)-th enable period EN2-3a.

In an embodiment, the duration of a first front period FP1a may be longer than the duration of a second front period FP2a, and the duration of the second front period FP2a may be longer than the duration of a third front period FP3a. For example, the longer the durations of the second enable periods EN2-1a, EN2-2a, and EN2-3a are, the longer the durations of corresponding enable periods AP1a, AP2a, and AP3a may be and the shorter the durations of the front periods FP1a, FP2a, and FP3a may be.

However, embodiments of the present inventive concept are not necessarily limited to the timing diagrams of the first, second, and third compensation scan signals GCa, GCb, and GCc illustrated in FIGS. 9A and 9B, and to achieve the purpose of the present invention, the durations of the second enable periods EN2-1, EN2-2, and EN2-3, the duration of the front period FP, and the duration of the activation period AP may be set variously. For example, in some embodiments the durations of the second enable periods EN2-1, EN2-2, and EN2-3 may all be the same as each other. Alternatively, the durations of two of the second enable periods EN2-1, EN2-2, and EN2-3 may be the same as each other.

According to an embodiment of the present inventive concept, when the compensation scan signals GCa, GCb, and GCc transition to the deactivation level and the activation level, the voltage level may change through the first intermediate level or the second intermediate level. The compensation scan signals GCa, GCb, and GCc may have the first intermediate level during the front period FP preceding (e.g., immediately preceding) the start point of the activation period AP and the second intermediate level during the back period BP following (e.g., immediately following) the end point of the activation period AP. The compensation scan signals GCa, GCb, and GCc may prevent the voltage level from changing abruptly by including the front period FP and the back period BP, and therefore, it is possible to provide the display device DD with reduced power consumption (see FIG. 3).

In addition, according to an embodiment of the present inventive concept, by controlling the durations of the second enable periods EN2-1, EN2-2, and EN2-3, the durations of the front period FP and the activation period AP of each of the compensation scan signals GCa, GCb, and GCc may be controlled. Depending on the durations of the front period FP and the activation period AP, a difference in luminance may occur between odd-numbered row pixels and even-numbered row pixels. However, by controlling the durations of the front period FP and the activation period AP so that the difference in luminance between the odd-numbered row pixels and the even-numbered row pixels adjacent to each other is minimized, it is possible to increase the display quality of the display device DD (see FIG. 3).

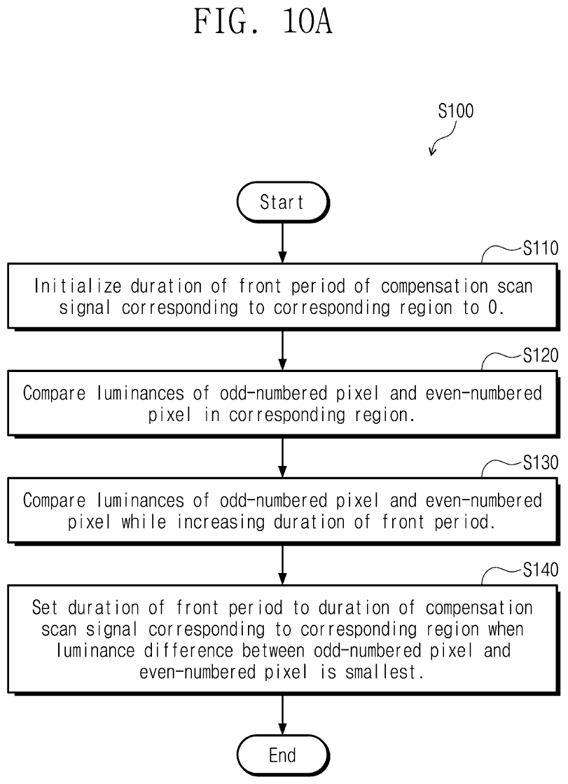

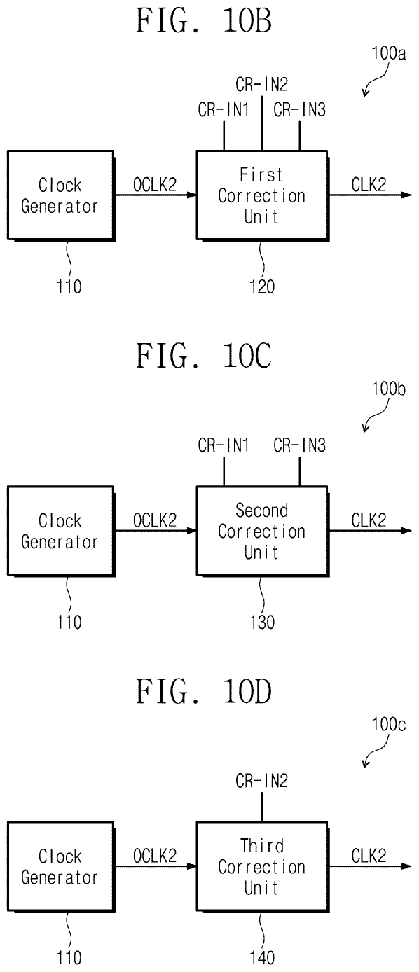

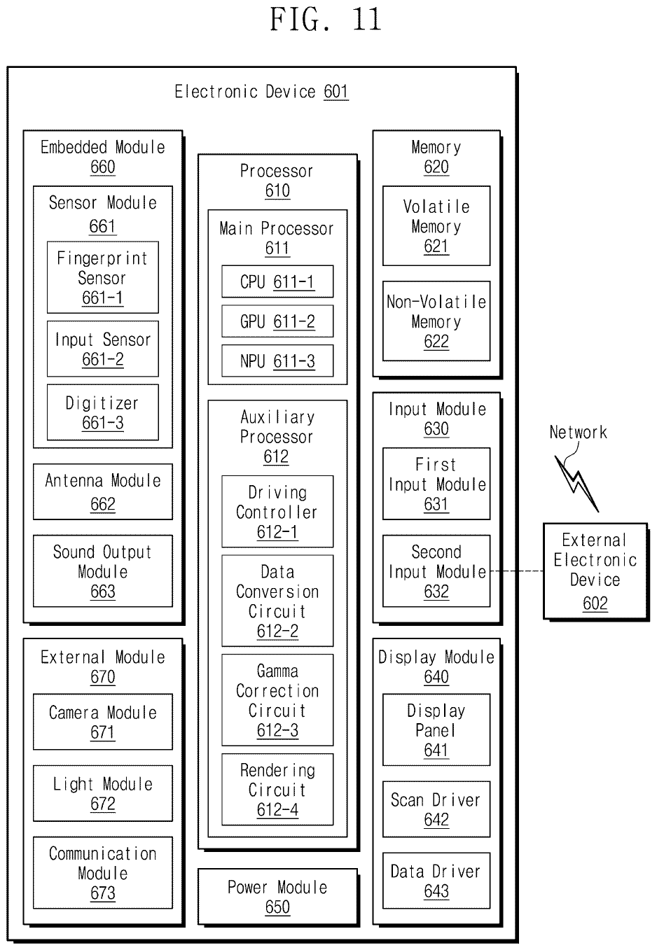

FIG. 10A is a flowchart for setting the duration of a front period according to an embodiment of the present inventive concept. FIG. 10B is a block diagram of a driving controller according to an embodiment of the present inventive concept. FIG. 10C is a block diagram of a driving controller according to an embodiment of the present inventive concept. FIG. 10D is a block diagram of a driving controller according to an embodiment of the present inventive concept.

Referring to FIGS. 9A and 10A, the duration of each front period FP may be set according to an embodiment of the present inventive concept in Step S100. Since Step S100 relates to a method for setting the duration of the front period FP corresponding to one compensation scan signal, Step S100 may be repeated to set the duration of each front period FP. Hereinafter, a method for setting the duration of the first front period FP1 of the first compensation scan signal GCa will be described.

First, the duration of the first front period FP1 of the first compensation scan signal GCa provided to the first display region DA1 (see FIG. 5) is initialized to 0 in Step S110. According to the duration of the first activation period AP1 set to correspond to the duration of the first front period FP1, the luminance of the odd-numbered row pixels and the luminance of the even-numbered row pixels in the first display region DA1 (see FIG. 5) are compared with each other in Step S120 (hereinafter, the difference in luminance between the odd-numbered row pixels and the even-numbered row pixels may be referred to as a luminance difference). The luminance of the odd-numbered row pixels and the luminance of the even-numbered row pixels are compared with each other while increasing the duration of the first front period FR1 in Step S130. After comparing the luminance difference for the duration of the first front period FR1 within a preset range, the duration of the first front period FR1 of the first compensation scan signal GCa provided to the first display region DA1 (see FIG. 5) is set to a duration when the luminance difference between the odd-numbered row pixels and the even-numbered row pixels is the smallest in Step S140. The duration of the second front period FR2 of the second compensation scan signal GCb provided to each of the second and third display regions DA2 and DA3 (see FIG. 5) and the duration of the third front period FR3 of the third compensation scan signal GCc may also be set by repeating Step S100.

Referring to FIGS. 9A and 10B, a driving controller 100a according to an embodiment of the present inventive concept may include a clock generator 110 and a first correction unit 120.

The clock generator 110 may generate clock signals at a preset interval. FIGS. 10B, 10C, and 10D illustrate the output of a second raw clock signal OCLK2 from the clock generator 110.

In an embodiment, the second raw clock signal OCLK2 generated from the clock generator 110 may be corrected to the second clock signal CLK2 through the first correction unit 120 and output to the second driving driver 400 (see FIG. 5).

In an embodiment, the first correction unit 120 may receive the second raw clock signal OCLK2, a first correction information CR-IN1, a second correction information CR-IN2, and a third correction information CR-IN3 and output the second clock signal CLK2. Each of the first correction information CR-IN1, the second correction information CR-IN2, and the third correction information CR-IN3 may include information on the duration of the front period FR calculated through Step S100 illustrated in FIG. 10A. For example, the first correction information CR-IN1 may include information on the duration of the first front period FR1, the second correction information CR-IN2 may include information on the duration of the second front period FR2, and the third correction information CR-IN3 may include information on the duration of the third front period FR3.

The first correction unit 120 may correct the durations of the second enable periods EN2-1, EN2-2, and EN2-3 of the second clock signal CLK2 by reflecting the first, second, and third correction information CR-IN1, CR-IN2, and CR-IN3 onto the second raw clock signal OCLK2. For example, the duration of the (2-1)-th enable period EN2-1 may be set by reflecting the information on the duration of the first front period FR1 included in the first correction information CR-IN1. Likewise, the durations of the (2-2)-th and (2-3)-th enable periods EN2-2 and EN2-3 may be set by reflecting the information on the duration of the second and third front periods FR2 and FR3 included in the second and third correction information CR-IN2 and CR-IN3.

Referring to FIGS. 9A and 10C, in an embodiment the driving controller 100b according to an embodiment of the present inventive concept may include a clock generator 110 and a second correction unit 130.

In an embodiment, the second raw clock signal OCLK2 generated from the clock generator 110 may be corrected to the second clock signal CLK2 through the second correction unit 130 and output to the second driving driver 400 (see FIG. 5).

In an embodiment, the second correction unit 130 may receive the second raw clock signal OCLK2, the first correction information CR-IN1, and the third correction information CR-IN3 and output the second clock signal CLK2. The first correction information CR-IN1 and the third correction information CR-IN3 may include information similar to the first correction information CR-IN1 and the third correction information CR-IN3 illustrated in FIG. 10B.

The second correction unit 130 may correct the durations of the second enable periods EN2-1, EN2-2, and EN2-3 of the second clock signal CLK2 by reflecting the first and third correction information CR-IN1 and CR-IN3 onto the second raw clock signal OCLK2. For example, the durations of the (2-1)-th and (2-3)-th enable periods EN2-1 and EN2-3 may be set by reflecting the information on the durations of the first and third front periods FR1 and FR3 included in the first and third correction information CR-IN1 and CR-IN3. In addition, the duration of the (2-2)-th enable period EN2-2 may be set by reflecting the information on the duration of the second front period FR2 calculated by using the durations of the first and third front periods FR1 and FR3. In an embodiment, the duration of the second front period FR2 may be set by interpolating the durations of the first and third front periods FR1 and FR3.

Referring to FIGS. 9A and 10D, a driving controller 100c according to an embodiment of the present inventive concept may include a clock generator 110 and a third correction unit 140.

In an embodiment, the second raw clock signal OCLK2 generated from the clock generator 110 may be corrected to the second clock signal CLK2 through the third correction unit 140 and output to the second driving driver 400 (see FIG. 5).

The third correction unit 140 may receive the second raw clock signal OCLK2 and the second correction information CR-IN2 and output the second clock signal CLK2. The second correction information CR-IN2 may include information similar to the second correction information CR-IN2 illustrated in FIG. 10B.

The third correction unit 140 may reflect the second correction information CR-IN2 onto the second raw clock signal OCLK2 to correct the durations of the second enable periods EN2-1, EN2-2, and EN2-3 of the second clock signal CLK2. For example, the duration of the (2-2)-th enable period EN2-2 may be set by reflecting the information on the duration of the second front period FR2 included in the second correction information CR-IN2. In addition, the third correction unit 140 may set a first compensation value and a second compensation value. Here, the first compensation value may be set as the difference between the duration of the first front period FR1 and the duration of the second front period FR2 when the luminance difference is minimum in the first display region DA1 (see FIG. 5), and the second compensation value may be set as the difference between the duration of the third front period FR3 and the duration of the second front period FR2 when the luminance difference is minimum in the third display region DA3 (see FIG. 5). Hereafter, the duration of the first front period FR1 may be set by correcting the duration of the second front period FR2 with the first compensation value, and the duration of the third front period FR3 may be set by correcting the duration of the second front period FR2 with the second compensation value. In an embodiment, the first compensation value and the second compensation value may be equal to each other. The third correction unit 140 may set the durations of the (2-1)-th and (2-3)-th enable periods EN2-1 and EN2-3 by reflecting the information on the corrected first and third front periods FR1 and FR3.

However, embodiments of the present inventive concept are not necessarily limited thereto, and the first, second, and third correction units 120, 130, and 140 illustrated in FIGS. 10B to 10D may be deactivated so that the second raw clock signal OCLK2 is not corrected and may be output as the second clock signal CLK2 to the second driving driver 400 (see FIG. 5). In this case, the durations of the second enable periods EN2-1, EN2-2, and EN2-3 included in the second clock signal CLK2 may all be the same as each other.

FIG. 11 is a block diagram of an electronic device according to an embodiment of the present inventive concept.

Referring to FIG. 11, the electronic device 601 outputs various information through a display module 640 within an operating system. When a processor 610 executes an application stored in a memory 620, the display module 640 provides application information to a user through a display panel 641.

The processor 610 obtains an external input through an input module 630 or a sensor module 661 and executes an application corresponding to the external input. For example, when a user selects a camera icon displayed on the display panel 641, the processor 610 obtains a user input through an input sensor 661-2 and activates a camera module 671. The processor 610 transmits image data, which correspond to a captured image obtained through the camera module 671, to the display module 640. The display module 640 may display an image corresponding to the captured image through the display panel 641.

In an embodiment, when personal information authentication is executed in the display module 640, a fingerprint sensor 661-1 obtains input fingerprint information as input data. The processor 610 compares the input data obtained through the fingerprint sensor 661-1 with authentication data stored in the memory 620 and executes the application according to a comparison result. The display module 640 may display information executed according to the logic of the application through the display panel 641.

In an embodiment, when a music streaming icon displayed on the display module 640 is selected, the processor 610 obtains a user input through the input sensor 661-2 and activates a music streaming application stored in the memory 620. When a music execution command is input from the music streaming application, the processor 610 activates a sound output module 663 to provide a user with sound information corresponding to the music execution command.

In the above, the operation of the electronic device 601 has been briefly described. The configuration of the electronic device 601 will be described in detail below. Some of the components of the electronic device 601 described below may be integrated and provided as one component, or one component may be provided by separating it into two or more components.

Referring to FIG. 11, the electronic device 601 may communicate with an external electronic device 602 via a network (e.g., a short-range wireless communication network or a long-range wireless communication network). According to an embodiment of the present inventive concept, the electronic device 601 may include a processor 610, a memory 620, an input module 630, a display module 640, a power module 650, an embedded module 660, and an external module 670. According to an embodiment of the present inventive concept, the electronic device 601 may omit at least one of the above-described components, or one or more other components may be added. According to an embodiment of the present inventive concept, some of the above-described components (e.g., the sensor module 661, the antenna module 662, or the sound output module 663) may be integrated into another component (e.g., a display module 640).

The processor 610 may execute software to control at least one other component (e.g., a hardware or software component) of the electronic device 601 connected to the processor 610 and may perform various data processing or calculations. According to an embodiment of the present inventive concept, as at least a portion of the data processing or calculations, the processor 610 may store commands or data received from other components (e.g., the input module 630, the sensor module 661, or a communication module 673) in a volatile memory 621, process the commands or data stored in the volatile memory 621, and store the result data in a non-volatile memory 622.

The processor 610 may include a main processor 611 and an auxiliary processor 612. The main processor 611 may include one or more of a central processing unit (CPU) 611-1 or an application processor (AP). The main processor 611 may further include one or more of a graphic processing unit (GPU) 611-2, a communication processor (CP), and an image signal processor (ISP). The main processor 611 may further include a neural processing unit (NPU) 611-3. The neural processing unit is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but the embodiment of the present inventive concept is not limited to the examples described above. In addition to the hardware structure, the artificial intelligence model may additionally or alternatively include a software structure. At least two of the above-described processing units and processors may be implemented as a single integrated component (e.g., a single chip), or each may be implemented as an independent component (e.g., a plurality of chips).

The auxiliary processor 612 may include a driving controller 612-1. The driving controller 612-1 may include an interface conversion circuit and a timing control circuit. The driving controller 612-1 receives an image signal from the main processor 611, converts the data format of the image signal to match the interface specifications of the display module 640, and outputs image data. The driving controller 612-1 may output various control signals necessary for driving the display module 640. Since the configuration of the driving controller 612-1 is substantially similar to the driving controller 100 illustrated in FIG. 3, a detailed description thereof will be omitted.

The auxiliary processor 612 may further include a data conversion circuit 612-2, a gamma correction circuit 612-3, a rendering circuit 612-4, etc. The data conversion circuit 612-2 may receive image data from the driving controller 612-1 and compensate for the image data so that the image is displayed at a desired luminance according to the characteristics of the electronic device 601, a user's settings, or the like, or may convert the image data to reduce power consumption or compensate for afterimages, etc. The gamma correction circuit 612-3 may convert the image data, a gamma reference voltage, or the like so that the image displayed on the electronic device 601 has a desired gamma characteristic. The rendering circuit 612-4 may receive the image data from the driving controller 612-1 and render the image data in consideration of the pixel layout of the display panel 641 and the like applied to the electronic device 601. At least one of the data conversion circuit 612-2, the gamma correction circuit 612-3, or the rendering circuit 612-4 may be integrated into another component (e.g., the main processor 611 or the driving controller 612-1). At least one of the data conversion circuit 612-2, the gamma correction circuit 612-3, or the rendering circuit 612-4 may also be integrated into a data driver 643 to be described below.

The memory 620 may store various data used by at least one component of the electronic device 601 (e.g., the processor 610 or the sensor module 661) and input data or output data for commands related thereto. The memory 620 may include at least one of a volatile memory 621 or a non-volatile memory 622.

The input module 630 may receive commands or data to be used for the components of the electronic device 601 (e.g., the processor 610, the sensor module 661, or the sound output module 663) from outside the electronic device 601 (e.g., a user or an external electronic device 602).

The input module 630 may include a first input module 631 through which commands or data are input from a user, and a second input module 632 through which commands or data are input from the external electronic device 602. The first input module 631 may include a microphone, a mouse, a keyboard, a key (e.g., a button), or a pen (e.g., a passive pen or an active pen). The second input module 632 may support a designated protocol that may be connected to the external electronic device 602 by wire or wirelessly. According to an embodiment of the present inventive concept, the second input module 632 may include a high definition multimedia interface (HDMI), a universal serial bus (USB) interface, an SD card interface, or an audio interface. The second input module 632 may include a connector that may be physically connected to the external electronic device 602, for example, an HDMI connector, a USB connector, an SD card connector, or a sound connector (e.g., a headphone connector).

The display module 640 provides information visually to a user. The display module 640 may include a display panel 641, a scan driver 642, and a data driver 643. The display module 640 may further include a window, a chassis, and a bracket for protecting the display panel 641. The display module 640 may further include a light-emitting driver, a voltage generator, and the like. The voltage generator may output various voltages required to drive the display panel 641 (e.g., first and second driving voltages ELVDD and ELVSS) (see FIG. 4A). The configuration of the display panel 641, the scan driver 642, the data driver 643, and the voltage generator is substantially similar to that of the display panel DP, the first and second driving drivers 300 and 400, and the data driver 200 illustrated in FIG. 3, and therefore, a detailed description thereof will be omitted for economy of explanation.

The power module 650 supplies power to the components of the electronic device 601. The power module 650 may include a battery that charges a power voltage. The battery may include a non-rechargeable primary cell, a rechargeable secondary cell, or a fuel cell. The power module 650 may include a power management integrated circuit (PMIC). The power management integrated circuit supplies power optimized for each of the modules described above and the modules described below. The power module 650 may include a wireless power transmission/reception member electrically connected to the battery. The wireless power transmission/reception member may include a plurality of coil-shaped antenna radiators.

The electronic device 601 may further include an embedded module 660 and an external module 670. The embedded module 660 may include a sensor module 661, an antenna module 662, and a sound output module 663. The external module 670 may include a camera module 671, a light module 672, and a communication module 673.

The sensor module 661 may sense an input by a user's body or an input by a pen among the first input module 631 and generate an electric signal or data value corresponding to the input. The sensor module 661 may include at least any one of a fingerprint sensor 661-1, an input sensor 661-2, or a digitizer 661-3.

The fingerprint sensor 661-1 may generate a data value corresponding to a user's fingerprint. The fingerprint sensor 661-1 may include any one of an optical or capacitance fingerprint sensor.

The input sensor 661-2 may generate a data value corresponding to the coordinate information of an input by a user's body or an input by a pen. The input sensor 661-2 generates the data value based on changes in capacitance caused by the input. The input sensor 661-2 may sense an input from a passive pen, or transmit and receive data with an active pen.

The input sensor 661-2 may also measure a biometric signal such as blood pressure, moisture, or body fat. For example, when a user touches a sensor layer or a sensing panel with a part of his or her body and does not move for a certain period of time, the input sensor 661-2 may sense the biometric signal based on changes in an electric field caused by the body part and output the information desired by the user to the display module 640.

The digitizer 661-3 may generate a data value corresponding to the coordinate information of an input by a pen. The digitizer 661-3 generates the data value based on an electromagnetic change amount caused by the input. The digitizer 661-3 may sense an input by a passive pen or transmit and receive data with an active pen.

At least one of the fingerprint sensor 661-1, the input sensor 661-2, and the digitizer 661-3 may be implemented as a sensor layer formed on the display panel 641 through a continuous process. The fingerprint sensor 661-1, the input sensor 661-2, and the digitizer 661-3 may be disposed on the upper side of the display panel 641, and one of the fingerprint sensor 661-1, the input sensor 661-2, and the digitizer 661-3, for example, the digitizer 661-3 may be disposed on the lower side of the display panel 641.

At least two of the fingerprint sensor 661-1, the input sensor 661-2, and the digitizer 661-3 may be formed to be integrated into one sensing panel through a same process. When integrated into one sensing panel, the sensing panel may be disposed between the display panel 641 and the window disposed on the upper side of the display panel 641. According to an embodiment of the present inventive concept, the sensing panel may be disposed on the window, and the position of the sensing panel is not particularly limited.

At least one of the fingerprint sensor 661-1, the input sensor 661-2, or the digitizer 661-3 may be embedded in the display panel 641. That is, at least one of the fingerprint sensor 661-1, the input sensor 661-2, and the digitizer 661-3 may be formed simultaneously through a process of forming the elements (e.g., a light-emitting element, a transistor, etc.) included in the display panel 641.

In addition, the sensor module 661 may generate an electric signal or a data value corresponding to the internal state or external state of the electronic device 601. The sensor module 661 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 662 may include one or more antennas for transmitting or receiving signals or power to or from the outside. According to an embodiment of the present inventive concept, the communication module 673 may transmit a signal to an external electronic device or receive a signal from an external electronic device through an antenna suitable for a communication method. The antenna pattern of the antenna module 662 may be integrated into one component of the display module 640 (e.g., the display panel 641) or the input sensor 661-2.

The sound output module 663 is a device for outputting a sound signal to the outside of the electronic device 601 and may include, for example, a speaker used for general purposes such as multimedia playback or record playback and a receiver used exclusively for phone call reception. According to an embodiment of the present inventive concept, the receiver may be formed integrally with or separately from the speaker. The sound output pattern of the sound output module 663 may be integrated into the display module 640.

The camera module 671 may capture still images and moving images. According to an embodiment of the present inventive concept, the camera module 671 may include one or more lenses, an image sensor, or an image signal processor. The camera module 671 may further include an infrared camera capable of measuring the presence or absence of a user, the location of the user, the line of sight of the user, etc.

The light module 672 may provide light. The light module 672 may include a light-emitting diode or a xenon lamp. The light module 672 may operate in conjunction with the camera module 671 or operate independently.

The communication module 673 may support the establishment of a wired or wireless communication channel between the electronic device 601 and the external electronic device 602 and the performance of communication through the established communication channel. The communication module 673 may include one or all of a wireless communication module such as a cellular communication module, a short-range wireless communication module, or a global navigation satellite system (GNSS) communication module, and a wired communication module such as a local area network (LAN) communication module or a power line communication module. The communication module 673 may communicate with the external electronic device 602 via a short-range communication network such as Bluetooth, WiFi direct or IrDA (infrared data association) or a long-range communication network such as a cellular network, the Internet, or a computer network (e.g., LAN or WAN). The various types of communication modules 673 described above may be implemented as one chip or each may be implemented as a separate chip.

The input module 630, the sensor module 661, the camera module 671, etc. may be utilized to control the operation of the display module 640 in conjunction with the processor 610.

The processor 610 outputs commands or data to the display module 640, the sound output module 663, the camera module 671, or the light module 672, based on input data received from the input module 630. For example, the processor 610 may generate image data in response to input data applied through a mouse, an active pen, or the like and output the image data to the display module 640. Alternatively, the processor 610 may generate command data in response to the input data and output the command data to the camera module 671 or the light module 672. When no input data is received from the input module 630 for a certain period of time, the processor 610 may switch the operation mode of the electronic device 601 to a low-power mode or a sleep mode to reduce power consumed by the electronic device 601.

The processor 610 outputs commands or data to the display module 640, the sound output module 663, the camera module 671, or the light module 672, based on sensing data received from the sensor module 661. For example, the processor 610 may compare authentication data applied by the fingerprint sensor 661-1 with the authentication data stored in the memory 620 and then execute an application based on the comparison result. The processor 610 may execute a command or output corresponding image data to the display module 640, based on the sensing data sensed by the input sensor 661-2 or the digitizer 661-3. When the sensor module 661 includes a temperature sensor, the processor 610 may receive temperature data regarding a measured temperature from the sensor module 661 and further perform luminance correction, etc. to the image data based on the temperature data.

The processor 610 may receive measurement data on the presence or absence of a user, the location of the user, the line of sight of the user, etc. from the camera module 671. The processor 610 may further perform luminance correction, etc. to the image data, based on the measurement data. For example, the processor 610, which determines the presence or absence of a user through an input from the camera module 671, may output the image data, whose luminance has been corrected through the data conversion circuit 612-2 or the gamma correction circuit 612-3, to the display module 640.

Some of the above components may be connected to each other through a communication method between peripheral devices, such as a bus, a general purpose input/output (GPIO), a serial peripheral interface (SPI), a mobile industry processor interface (MIPI), or an ultra path interconnect (UPI) link, to exchange signals (e.g., commands or data) with each other. The processor 610 may communicate with the display module 640 through an interface promised to each other and use, for example, any one of the above-described communication methods, and the embodiment of the present inventive concept is not limited to the above-described communication methods.

The electronic device 601 according to the various embodiments disclosed in this document may have various forms. The electronic device 601 may include, for example, at least one of a portable communication device (e.g., a smart phone), a computer device, a portable multimedia device, a portable medical device, a camera, a wearable device, or a home appliance device. The electronic device 601 according to the embodiments of this document is not necessarily limited to the above-described devices and may include various different small-sized, medium-sized or large-sized electronic devices.

According to an embodiment of the present inventive concept, a driving driver may output scan signals to a plurality of pixels. The scan signals may include a deactivation period having a deactivation level, an activation period having an activation level, and a front period having a first intermediate level. The scan signals may change from the deactivation level to the activation level through the first intermediate level. Accordingly, a voltage level may be prevented from changing rapidly, thereby being able to reduce the power consumption of a display device.

In addition, according to the present invention, by controlling the durations of the front period and the activation period of the scan signals, the luminance of the plurality of pixels may be controlled. By setting the durations of the front period and the activation period of the scan signals so that the difference in luminance between two adjacent pixels among the plurality of pixels is minimized, it is possible to provide a display device with increased display quality.

Although the above has been described with reference to non-limiting embodiments of the present inventive concept, those skilled in the art or those of ordinary skill in the art will understand that various modifications and changes can be made to the present inventive concept within the scope that does not depart from the spirit and technical field of the present inventive concept. Accordingly, the technical scope of the present inventive concept should not be limited to the content described in the detailed description of the specification.

What is claimed is:

1. A display device comprising:
a display panel comprising a plurality of pixels;
a data driver supplying data voltages to the plurality of pixels; and
a driving driver supplying write scan signals and compensation scan signals to the plurality of pixels,
wherein:
the write scan signals are respectively applied to a plurality of pixel rows;
each of the compensation scan signals is applied to two pixel rows adjacent to each other in a first direction among the plurality of pixel rows;
the plurality of pixels comprise a first pixel and a second pixel spaced apart from the first pixel in the first direction;
each of the compensation scan signals comprises an activation period having an activation level;
a first compensation scan signal among the compensation scan signals is applied to the first pixel and a second compensation scan signal among the compensation scan signals is applied to the second pixel; and
a duration of a first activation period of the first compensation scan signal is different from a duration of a second activation period of the second compensation scan signal.

2. The display device of claim 1, wherein the driving driver comprises a compensation driver receiving a first clock signal and a second clock signal and generating the compensation scan signals using the first clock signal and the second clock signal.

3. The display device of claim 2, wherein:
the activation period of the compensation scan signals starts in response to a start point of a second enable period of the second clock signal; and
the activation period of the compensation scan signals ends in response to an end point of a first enable period of the first clock signal.

4. The display device of claim 3, wherein the second clock signal comprises:
a (2-1)-th enable period overlapping the first activation period of the first compensation scan signal; and
a (2-2)-th enable period overlapping the second activation period of the second compensation scan signal,
wherein a duration of the (2-1)-th enable period is different from a duration of the (2-2)-th enable period.

5. The display device of claim 3, wherein each of the compensation scan signals further comprises:
a deactivation period having a deactivation level lower than the activation level; and
a front period having a first intermediate level between the activation level and the deactivation level, the front period preceding the start point of the second enable period.

6. The display device of claim 5, wherein a duration of a first front period of the first compensation scan signal is different from a duration of a second front period of the second compensation scan signal.

7. The display device of claim 6, wherein a sum of the duration of the first front period and the duration of the first activation period is equal to a sum of the duration of the second front period and the duration of the second activation period.

8. The display device of claim 6, wherein:
the plurality of pixels further comprise a third pixel spaced apart from the second pixel in the first direction; and
the second pixel is arranged between the first pixel and the third pixel.

9. The display device of claim 8, wherein:
a third compensation scan signal among the compensation scan signals is applied to the third pixel; and
a duration of a third front period of the third compensation scan signal is different from the duration of the first front period and the duration of the second front period.

10. The display device of claim 9, wherein:
the duration of the second front period is longer than the duration of the first front period; and
the duration of the third front period is longer than the duration of the second front period.

11. The display device of claim 9, wherein the duration of the second front period is set to a value calculated using the duration of the first front period and the duration of the third front period.

12. The display device of claim 9, wherein:
the duration of the first front period is obtained by correcting the duration of the second front period using a first compensation value; and
the duration of the third front period is obtained by correcting the duration of the second front period using a second compensation value.

13. The display device of claim 5, wherein:
each of the compensation scan signals further comprises a back period following the end point of the first enable period; and
each of the compensation scan signals has a second intermediate level between the activation level and the deactivation level in the back period.

14. The display device of claim 13, wherein a duration of a first back period of the first compensation scan signal is equal to a duration of a second back period of the second compensation scan signal.

15. The display device of claim 1, wherein each of the plurality of pixels comprises:
a light-emitting element;
a first transistor connected between the light-emitting element and a first power line;
a second transistor connected to the first transistor and receiving the data voltages and the write scan signals;
a third transistor connected to a control electrode of the first transistor and receiving the compensation scan signals; and
a fourth transistor connected to the control electrode of the first transistor and receiving an initialization scan signal and an initialization voltage,
wherein the first transistor and the second transistor are PMOS transistors, and the third transistor and the fourth transistor are NMOS transistors.

16. A display device comprising:
a display panel comprising a first display region and a second display region adjacent to the first display region in a first direction;
a data driver supplying data voltages to a plurality of pixels; and
a driving driver supplying write scan signals and compensation scan signals to the plurality of pixels,
wherein each pixel of the plurality of pixels comprises:
a light-emitting element;
a first transistor connected between the light-emitting element and a first power line;
a second transistor connected to a first electrode of the first transistor and receiving one of the write scan signals; and
a third transistor connected to a second electrode and a control electrode of the first transistor and receiving one of the compensation scan signals,
wherein:
each of the compensation scan signals comprises an activation period having an activation level, a deactivation period having a deactivation level lower than the activation level, and a front period having a first intermediate level between the activation level and the deactivation level; and
a duration of a first front period of a first compensation scan signal provided to the first display region is different from a duration of a second front period of a second compensation scan signal provided to the second display region.

17. The display device of claim 16, wherein the driving driver comprises a compensation driver receiving a first clock signal and a second clock signal and generating the compensation scan signals using the first clock signal and the second clock signal.

18. The display device of claim 17, wherein:
the activation period of the compensation scan signals starts in response to a start point of a second enable period of the second clock signal; and
the activation period of the compensation scan signals ends in response to an end point of a first enable period of the first clock signal.

19. The display device of claim 18, wherein:
the second clock signal comprises a (2-1)-th enable period overlapping a first activation period of the first compensation scan signal and a (2-2)-th enable period overlapping a second activation period of the second compensation scan signal,
wherein a duration of the (2-1)-th enable period is different from a duration of the (2-2)-th enable period.

20. An electronic device comprising:
a display panel comprising a plurality of pixels;
a data driver supplying data voltages to the plurality of pixels;
a driving driver supplying write scan signals and compensation scan signals to the plurality of pixels;
a driving controller receiving an image signal and a control signal and control an operation of the data driver and the driving driver; and
a main processor providing the image signal and the control signal to the driving controller,
wherein:
the write scan signals are respectively applied to a plurality of pixel rows;
each of the compensation scan signals is applied to two pixel rows adjacent to each other in a first direction among the plurality of pixel rows;
the plurality of pixels comprise a first pixel and a second pixel spaced apart from the first pixel in the first direction;
each of the compensation scan signals comprises an activation period having an activation level;
a first compensation scan signal among the compensation scan signals is applied to the first pixel and a second compensation scan signal among the compensation scan signals is applied to the second pixel; and
a duration of a first activation period of the first compensation scan signal is different from a duration of a second activation period of the second compensation scan signal.
